(19) United States
(12) Patent Application Publication
(10) Pub. No.: US 2026/0050068 A1
(43) Pub. Date: Feb. 19, 2026

(54) GLARE-RESISTANT LIDAR

(71) Applicant: AEye, Inc., Dublin, CA (US)

(72) Inventors: Noah Bronstein, Dublin, CA (US); Allan Steinhardt, Dublin, CA (US); Hod Finkelstein, Albany, CA (US); John Stockton, Austin, TX (US); Ankur Anchlia, Bangalore (IN)

(73) Assignee: AEye, Inc., Dublin, CA (US)

(21) Appl. No.: 19/103,527

(22) PCT Filed: Aug. 10, 2023
(86) PCT No.: PCT/US2023/029960

§ 371 Date: Feb. 12, 2025

Related U.S. Application Data
(60) Provisional application No. 63/397,778, filed on Aug. 12, 2022.

(51) Int. Cl. G01S 7/4865; G01S 7/481

(52) U.S. Cl. CPC G01S 7/4865; G01S 7/4815; G01S 7/4816

(57) ABSTRACT

Light detection and ranging (lidar) technology is capable of using light to measure the distance to objects in a field of view. A lidar system typically comprises a lidar transmitter, a lidar receiver, and a clock. The lidar transmitter transmits light into the field of view, and the light is reflected back to the lidar receiver after striking objects in the field of view. Techniques are described herein for encoding channel information into light transmissions so that the lidar receiver can use the encoded channel information to reduce the out-of-channel noise in channel-specific photodetection signals.

### CROSS-REFERENCE AND PRIORITY CLAIM TO RELATED PATENT APPLICATION

This patent application claims priority to U.S. provisional patent application 63/397,778, filed Aug. 12, 2022, and entitled “Glare-Resistant Lidar”, the entire disclosure of which is incorporated herein by reference.

### INTRODUCTION

Light detection and ranging (lidar) technology is capable of using light to measure the distance to objects in a field of view. A lidar system typically comprises a lidar transmitter, a lidar receiver, and a clock. The lidar transmitter transmits light into the field of view, and the light is reflected back to the lidar receiver after striking objects in the field of view. The lidar receiver senses the light reflected by the objects, and signal processing circuitry in the lidar receiver detects these light returns and measures times of flight (TOFs) for the light returns with the aid of the clock. The signal processing circuitry is able to compute ranges to the objects based on the TOF information (e.g., computing range by multiplying a TOF value by the speed of light and dividing by two).

Lidar systems typically employ either of two techniques for illuminating a scene: point illumination or flood illumination. With point illumination (e.g., scanning lidar), the emitted light is concentrated by the lidar transmitter on one or a few points in the field of view at a time. To illuminate the scene, this emitted light can be scanned over multiple points in the field of view over time. With flood illumination (e.g., flash lidar), the lidar transmitter illuminates the whole scene at once. However, it should be understood that some lidar systems may employ a hybrid approach where a portion in a field of view is flood illuminated at a given time (such portion being larger than the point illumination of a point illumination approach but smaller than the whole scene), and this portion-specific flood illumination is scanned from portion-to-portion in the field of view over time. Such a hybrid approach can also be described as employing flash lidar (e.g., scanning flash lidar).

Scanning lidar systems are able to isolate objects in the field of view and obtain the range to those isolated objects by focusing both the emitted light and the receiver's observation spot at the same location. This significantly reduces the risk of objects located elsewhere in the scene from being observed accidentally (which could cause the signal processing circuitry to report ranges at the observation spots which actually correspond to objects at a different observation spots).

By contrast, flash lidar illuminates the whole scene (or at least a larger portion of the scene than a particular point of interest) and receives return signals from the whole scene (or large portion of the scene) at once. These return signals are typically imaged by the lidar receiver using camera-like lenses which pass incident light onto an array of photodetectors, where each photodetector in the array is observing only a small part of the scene. This small part of the scene that is observed by a given photodetector can be referred to as a “channel” or “zone”. The return from the light emitted by the lidar transmitter that is intended to be detected by a photodetector that observes a given channel or zone serves as the “signal” (in contrast to “noise”). But, while each point in the scene is generally meant to be observed by one and only one photodetector in the array, this is not guaranteed to be the case. If for any reason the signal from one channel is detected by a photodetector for a different channel, this can cause the signal processing circuit to report a range on the one channel that was actually originating from the different channel. Such an incorrectly reported range is a “false positive” signal which means that the lidar system may report that something exists in a given channel that is not actually there. These false positives can be referred to as “channel mixing false positives”(or CMFPs).

Similarly, the light from outside the intended channel that gets detected within the intended channel can be encompassed within the term “out-of-channel noise” (or similarly, the term “cross-talk”). Thus, if a given photodetector is observing Channel A, this photodetector may also sense incident light from Channel B; and this light from Channel B that is incident on the photodetector for Channel A can be characterized as “out-of-channel noise”or “cross-talk”.

In a typical problematic scenario, a flash lidar system is ranging to a highly reflective or bright object in its field of view. Because of the out-of-channel noise problem discussed above, the flash lidar system may report this highly reflective or bright object as being much larger than it really is. This is because the signal from the highly reflective or bright object may be detected on many more channels than the object actually subtends in the field of view. Therefore, the range of the object is reported by the signal processing circuitry over a much broader range of angles than the object actually occupies. This general phenomenon has many names in other imaging systems where the name is linked to fundamental physical phenomena that cause the adverse effect to take a particular shape. For example, glare, halo, and lens flare are well-known types of adverse effects caused by out-of-channel noise or cross-talk. Another source of interference that may manifest itself as out-of-channel noise or cross-talk can be the presence of another lidar system in the vicinity (where the other lidar system may produce light that blinds, saturates, or otherwise interferences with the lidar system over a number of channels). In addition to these effects, which are optical in nature, there can also be electrical mechanisms that lead to similar results and thus also manifest themselves as out-of-channel noise or cross-talk within the output of a given channel's photodetector.

This out-of-channel noise/cross-talk problem is significant for flash lidar systems which are used in complex environments such as cities and highways. For example, a highly reflective object such as a stop sign (which may be only a half meter wide on the side of the road) might appear as if it were a large wall blocking the whole road because the light reflected by the stop sign might find its way into channels that correspond to the middle of the road. A vehicle traveling on the road and using a conventional flash lidar system to aid navigation may find it difficult to plan a safe path through this scene and could potentially crash into a person, another vehicle, or a stationary object in response to its misinterpretation of the stop sign. The reason that flash lidar is more sensitive to such noise is that the tight point spread function induced by receiver beam divergence (a function of the receiver optics) is the only source of optical isolation for the flash lidar system, whereas for a lidar system using point illumination both transmitter and receiver have a tight beam divergence and so the point spread functions are multiplied.

While scanning lidar systems will typically be less susceptible to the adverse effects of out-of-channel noise, there are other considerations that will often make flash lidar systems more desirable than scanning lidar systems. For example, fewer (or no) moving parts are needed for flash lidar systems, which implies improved reliability, improved longevity, simpler operation, and ultimately lower cost. Further still, parallelizing data collection on a flash lidar system can result in performance far in excess of a scanning lidar system since the number of channels that are in operation simultaneously can be orders of magnitude higher for flash lidar systems than for scanning lidar systems. Accordingly, there is a need in the art for the development of techniques that mitigate the out-of-channel noise problem that would enable flash lidar systems to be more reliably and widely deployed.

Toward these ends, the inventors disclose that channel information can be encoded in channel-specific light signals that are transmitted by the lidar transmitter of a lidar system toward different channels in the field of view. Photodetectors in the lidar receiver of the lidar system can listen for returns from their respective channels and produce channel-specific photodetection signals based on incident light received thereby. These photodetection signals can include out-of-channel noise. However, a signal processing circuit can filter the channel-specific photodetection signals based on the encoded channel information for their corresponding channels to reduce the presence of this out-of-channel noise. Received signals that do not correspond to the encoded channel information of the subject channel can be ignored, leading to improved signal quality in the filtered channel-specific photodetection signals. Returns of the channel-specific light signals can then be more reliably detected within these filtered channel-specific photodetection signals. By filtering the channel-specific photodetection signals in this manner, incidences of CMFPs can be reduced to achieve improved reliability for the lidar system.

Any of a number of techniques can be used to encode channel information in the channel-specific light signals.

For example, the channel-specific light signals can take the form of a pulse sequence comprising two or more light pulses (e.g., laser pulses), and channel information can be encoded into the channel-specific light signals by modulating the amplitudes of the pulses in the pulse sequences. In this fashion, the ratios of the pulse magnitudes as between the pulses of the pulse sequences can be used to denote the channels to which the pulse sequences are directed.

As another example, channel information can be encoded into the channel-specific light signals by modulating the time delays between the pulses in the pulse sequences. In this fashion, different time delays between pulses can be used to denote the channels to which the pulses sequences are directed.

As still another example, channel information can be encoded in the channel-specific light signals by randomizing the transmission times for the pulses of the pulse sequences for each channel. Each channel can have its own randomized transmission schedule of pulses, and the photodetectors corresponding to the different channels can synchronize their collection windows to these randomized transmission schedules. In this fashion, out-of-channel noise can be naturally filtered out of the channel-specific photodetection signals because the out-of-channel noise will be spread out over time in the channel-specific photodetection signals (while the in-channel return signal will be concentrated at a common reception time relative to the randomized transmission times).

These and other features and advantages of the invention will be described in greater detail below.

### BRIEF DESCRIPTION OF THE DRAWINGS

FIG. 1A depicts an example lidar system that uses channel-specific light signals and channel-specific return detection to mitigate the effects of out-of-channel noise in accordance with an example embodiment.

FIG. 1B shows example process flows for a lidar transmitter and lidar receiver that implement the example embodiment of FIG. 1A.

FIG. 2 shows an example pixel which can be used in an example embodiment.

FIG. 3 shows another example lidar system that uses channel-specific light signals and channel-specific return detection to mitigate the effects of out-of-channel noise in accordance with another example embodiment.

FIG. 4A shows an example where channel information is encoded in channel-specific light signals by modulating pulse magnitude.

FIG. 4B shows an example where channel information is encoded in channel-specific light signals by modulating the time between pulses.

FIG. 5A shows an example process flow for processing photodetection signals to reduce out-of-channel noise for an example embodiment where channel information is encoded in the channel-specific light signals via pulse magnitudes.

FIG. 5B shows an example process flow for processing photodetection signals to reduce out-of-channel noise for an example embodiment where channel information is encoded in the channel-specific light signals via time delays between pulses.

FIG. 6 shows an example simulation of a SPAD-based flash lidar system that observes two objects with different returned light intensities.

FIG. 7A shows an example plot of pulse magnitude (intensity) ratios for pulse pairs as a function of points (e.g., channels) in the field of view.

FIG. 7B shows an example image of peak magnitude ratio as between first and second detected peaks for the example object layout of FIG. 6.

FIG. 7C shows a difference image that represents the difference between the peak magnitude ratio of FIG. 7B and the encoded pulse magnitudes of FIG. 7A for the example object layout of FIG. 6.

FIG. 7D shows example results from using an intensity ratio azimuthal encoding approach for mitigating out-of-channel noise on a simulated SPAD-based flash lidar system for the example object layout of FIG. 6.

FIGS. 8A and 8B show an example approach for encoding channel information in channel-specific light signals using randomized transmission times for the channel-specific light signals.

FIG. 9 shows an example process flow for mitigating out-of-channel noise using the randomized transmission time approach of FIGS. 8A and 8B.

FIG. 10 shows an example clocking approach for the examples of FIGS. 8A, 8B, and 9.

FIG. 11 shows an example channel-specific histogram plot that can be produced when using the randomized transmission time approach of FIGS. 8A, 8B, and 9.

FIG. 12 shows an example distributed lidar system that can use the channel encoding techniques described herein to reduce out-of-channel noise.

### DETAILED DESCRIPTION OF EXAMPLE EMBODIMENTS

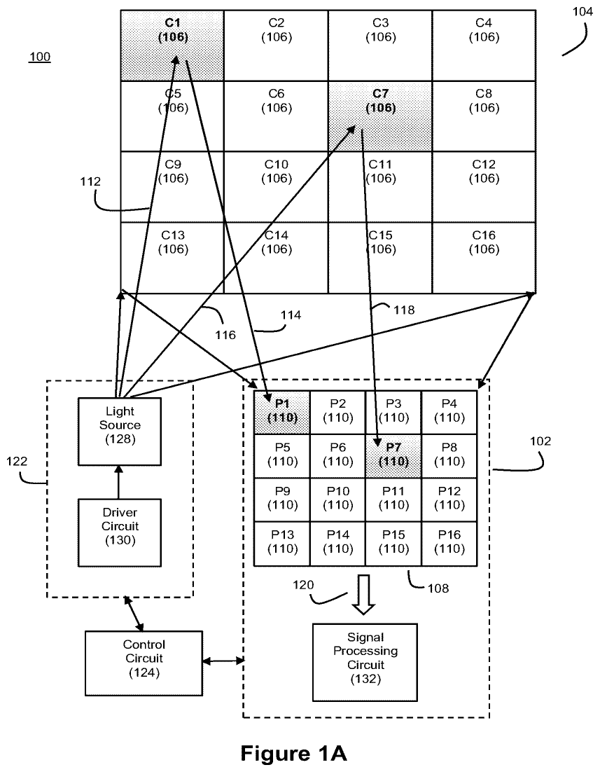

FIG. 1A depicts an example lidar system 100 in accordance with an example embodiment. The lidar system 100 comprises a lidar receiver 102 and a lidar transmitter 122.

The lidar receiver 102 includes a photodetector array 108 that collects light from a field of view 104. The field of view 104 includes a plurality of channels 106, where each channel 106 represents a particular field of view (or observation zone) of an individual pixel 110 of the photodetector array 108. Thus, each pixel 110 has a different channel field of view as shown by channels 106 of FIG. 1A. For example, pixel P1 has a channel field of view corresponding to channel C1, pixel P2 has a channel field of view corresponding to channel C2, and so on for the other pixels 110 of the photodetector array 108. It should be understood that the different channels 106 may be non-overlapping or overlapping relative to each other depending on the desires of a practitioner. Furthermore, overlap between channels 106 may arise due to conditions beyond a designer's control, such as multipath or glare which will cause “bleeding” on the transmit side from one channel to another. While the example of FIG. 1A shows a photodetector array 108 with a 4×4 array of pixels 110, it should be understood that the photodetector array 108 may include a much larger number of pixels 110. Further still, each pixel 110 may comprise one or more photodetectors that produce a photodetection signal in response to sensing incident light thereon.

As incident light is sensed by the pixels 110 of the photodetector array 108, photodetection signals 120 are generated. A signal processing circuit 132 can process these photodetection signals 120 to perform operations such as computing ranges to objects in the field of view 104. As discussed in greater detail below, these photodetection signals 120 are channel-specific and can be processed by the signal processing circuit 132 to reduce the presence of out-of-channel noise in signals 120. The signal processing circuit 132 may include a processor and memory that carry out the signal processing operations described herein. As examples, the processor may comprise hardware resources such as an application-specific integrated circuit (ASIC) and/or field programmable gate array (FPGA), although it should be understood that other types of processors such as digital signal processors or the like that execute software could also be employed.

The lidar transmitter 122 includes a light source 128 that transmits channel-specific light signals (e.g., see 112, 116) into a field of illumination. It should be understood that the example of FIG. 1A shows an instance where the lidar transmitter's field of illumination is the same as the lidar receiver's field of view 104, although this need not necessarily be the case. The lidar transmitter 122 can encode channel information in the channel-specific light signals such as 112, 116 so that each light signal emitted by the light source 128 toward a given channel 106 is encoded differently than the light signals emitted by the light source 128 toward other channels 106. A driver circuit 130 can drive the light source 128 to emit the light signals in this channel-specific manner.

By making the light signals channel-specific, this means that the signal processing circuit 132 can use the encoded channel information to distinguish the in-channel return signal from the out-of-channel noise to support filtering of the channel-specific photodetection signals 120 in a manner that reduces the presence of out-of-channel noise therewithin. For example, by distinguishing whether a signal is arriving at the intended channel, a determination can be made to ignore received signals which are detected from a channel that is not the intended channel. These points, which are CMFPs, can then be discarded, resulting in a reduction in the number of CMFPs. It should be understood that this out-of-channel noise that may manifest as CMFPs may arise from any of a number of causes, whether they may be ambient light, multipath light, interfering light from another lidar system, etc. Moreover, this out-of-channel noise may be spatial or temporal in nature.

The lidar system 100 can also include a control circuit 124 that acts as a system controller to coordinate the operations of the lidar transmitter 122 and lidar receiver 102. For example, the control circuit 124 can define the channel-specific encoding to be used by the lidar transmitter 122 and share this channel-specific encoding with the lidar receiver 102 to support the filtering operations.

It should also be understood that FIG. 1A shows various components of the lidar system 100 for ease of illustration. The lidar system 100 may include a number of additional components that are not shown by FIG. 1A. For example, the lidar receiver 102 may include additional components such as receive optics (e.g., one or more lenses) that direct incident light onto the photodetector array 108. Each pixel 110 may have corresponding amplifier circuitry for amplifying its photodetection signals, and the lidar receiver 102 may include readout circuitry for reading out the photodetection signals from the pixels 110. As another example, the lidar transmitter 122 may include additional components such as transmit optics (e.g., one or more lenses) that direct the emitted light signals toward their intended channels 106.

These are just examples, and the lidar system 100 may include other components if desired by a practitioner.

FIG. 1B shows example process flows for the lidar transmitter 122 and lidar receiver 102 to implement channel-specific encoding to mitigate the effects of out-of-channel noise.

The process flow shown at left in FIG. 1B is to be performed by the lidar transmitter 122. At step 150, the lidar transmitter 122 encodes channel information in the channel-specific light signals to be emitted by the light source 128 (e.g., see 112, 116). At step 152, the lidar transmitter 122 transmits these channel-specific light signals toward their corresponding channels 106 in the field of view 104. As discussed below, any of a number of different techniques can be used to encode channel information in these channel-specific light signals.

The process flow shown at right in FIG. 1B is to be performed for each pixel 110 of the lidar receiver 102. As explained above, each pixel 110 will have a channel-specific field of view, and at step 160 the subject pixel 110 receives and senses light that is incident thereon. This incident light may include out-of-channel noise, particularly if there is a highly reflective or bright object near the subject channel 106 for the subject pixel 110. At step 162, the subject pixel 110 produces a photodetection signal 120 in response to the received incident light. This photodetection signal 120 will include a return signal component corresponding to the reflection of the channel-specific light signal emitted by the lidar transmitter 122 toward the subject channel 106 as well as a noise component arising from out-of-channel noise. Thus, with reference to FIG. 1A, channel-specific light signal 112 will be reflected by an object in channel C1 so that return signal 114 can be sensed by pixel P1 of the photodetector array 108; and channel-specific light signal 116 will be reflected by an object in channel C7 so that return signal 118 can be sensed by pixel P7 of the photodetector array 108.

At step 164, the signal processing circuit 132 filters the photodetection signal 120 for the subject channel 106 using the encoded channel information for the subject channel 110. In doing so, the signal processing circuit 132 reduces the presence of out-of-channel noise in the photodetection signal 120 for the subject channel 106.

Thus, at step 166, the signal processing circuit 132 can process the filtered photodetection signal to detect the channel-specific return from the channel-specific light signal for the subject channel 106. Based on this detected channel-specific return, the signal processing circuit can more accurately determine the range to the object in the subject channel 106. Examples of techniques that can be used to perform steps 164 and 166 are discussed in greater detail below.

These steps 160, 162, 164, and 166 of FIG. 1B can be performed for each pixel 110 of the photodetector array 108 with respect to the pixels'corresponding channels 106.

The lidar transmitter 122 can be a scanning lidar transmitter or a flash lidar transmitter depending on the desires of a practitioner. But, as noted above, the inventors believe that the techniques for mitigating out-of-channel noise described herein can be especially useful for use with flash lidar systems.

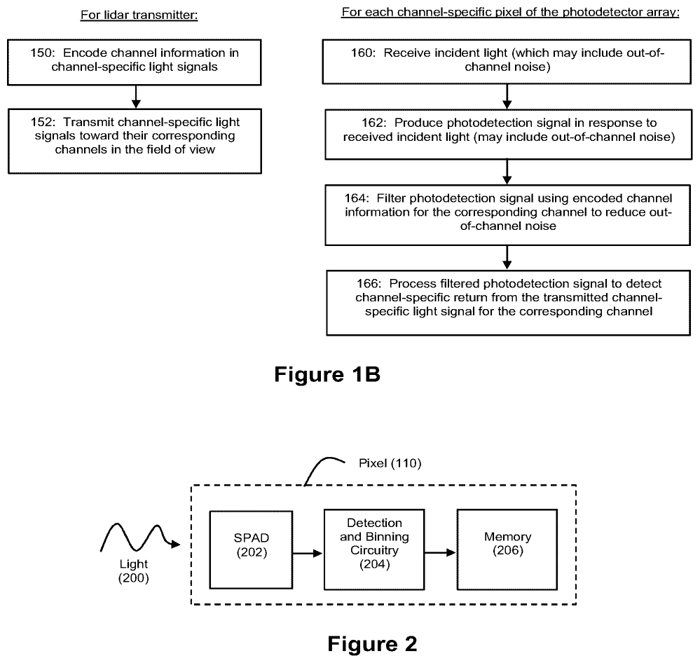

In an example flash lidar system, the photodetector array 108 can use single photon avalanche diodes (SPADs) as the photodetectors. With such an approach, each pixel 110 can employ an architecture such as that shown by the example of FIG. 2. With FIG. 2, each pixel 110 can comprise one or more SPADs 202 that receive incident light 200. Detection and binning circuitry 204 can process photodetection signals from the SPAD(s) 202 to generate histogram data for storage in memory 206. As such, the detection and binning circuitry 204 can be referred to as a histogram circuit. With a flash lidar system, the lidar transmitter 122 will emit, for each channel 106, a plurality of channel-specific light signals over a plurality of cycles that define a lidar frame. The corresponding pixel 110 for the subject channel will be synchronized for each cycle to collect light over a collection window after each channel-specific light signal is emitted. The detection and binning circuitry 204 (or histogram circuit) can employ binning techniques that operate to bin photodetection signals generated by the SPAD(s) 202 as a function of the time within the collection window that the photodetection signal is triggered. Each bin of the histogram can correspond to a range to an object in the subject channel 106. As this process is repeated over the cycles of the lidar frame, a peak will arise in at least one of the histogram bins that corresponds to the return signal from an object that is present in the subject channel 106. However, with a conventional flash lidar system, if there are any highly reflective or bright objects in the field of view 104 outside the subject channel 106, the histogram data for the subject channel 106 may also show peaks in one or more other bins of the histogram, which may cause the signal processing circuit to produce CMFPs. However, the use of channel-specific encoding in the transmitted light signals in combination with steps 164 and 166 of FIG. 1B can mitigate this out-of-channel noise problem.

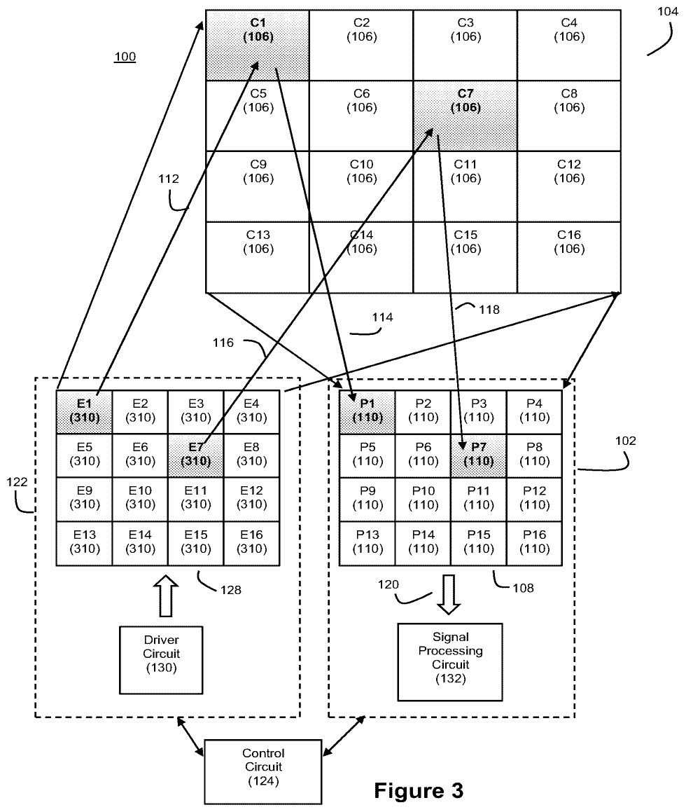

With a flash lidar system, the light source 128 may take the form of an array of light emitters 310 as shown by FIG. 3. With this approach, each light emitter 310 of the light source 128 can direct its emitted channel-specific light signal toward its corresponding channel 106. The lidar transmitter 122 can include transmit optics that facilitate these directional transmissions. For example, optical elements such as diffractive optical elements (DOEs), refractive optical elements, or micro-lenses can be positioned on the light emitters 310 to shape and steer the emitted light in a desired direction with a desired channel-specific encoding. As examples, the light source 128 can take the form of an array of semiconductor diode lasers such as Vertical Cavity Surface Emitting Lasers (VCSELs) or edge emitting lasers. In the example of FIG. 3, each laser emitter (see E1, E2, etc.) of the light source array 128 directs its channel-specific light signal to a particular channel 106 (see C1, C2, etc.). Thus, in this example, laser emitter E1 emits a channel-specific light signal to channel C1 (see 112), laser emitter E2 emits a channel-specific light signal to channel C2, etc. (e.g., see laser emitter E7 which emits channel-specific light signal 116 to channel C7). Driver circuit 130 can drive the emitters (E1, E2, etc.) with different electrical drive signals to create the channel-specific light signals.

As noted above, any of a number of techniques can be used to encode channel information in the channel-specific light signals (e.g., see 112, 116 in FIGS. 1A and 3). The encoded channel information can be information that identifies a characteristic of the subject channel 106. For example, the channel information can be the azimuth angle for the channel 106. As another example, the channel information can be the elevation angle for the channel 106. As yet another example, for even greater precision, the channel information can be the azimuth angle and elevation angle for the channel 106.

### Encoding Channel Information in Light Signals by Modulating Pulse Magnitudes

As a first encoding example, the channel-specific light signal can comprise a pulse sequence of two or more pulses, and the channel information can be encoded in the light signal through two or more sequential pulses with varying strengths. For example, the lidar transmitter 122 can modulate the intensity (magnitude) of the pulses in the pulse sequence so that there are differences among the channels 106 with respect to the magnitudes of the pulses. In this fashion, different ratios of pulse magnitudes can be used to denote different channels 106.

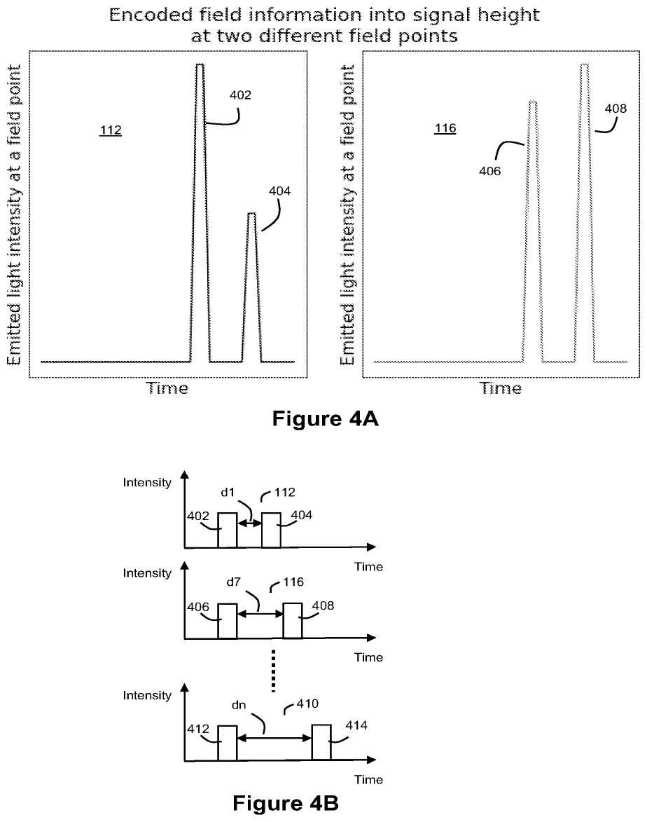

In the examples discussed below where channel information is encoded in the pulse sequence by varying the strength of the pulses, the pulse sequence is a pulse pair (a sequence of 2 pulses). However, it should be understood that the techniques discussed below can be readily extended to longer pulses sequences (e.g., pulse trains of 3 or more pulses). An example of encoding channel information in pulse pairs is shown by FIG. 4A. In this example, channel-specific light signal 112 (for Channel C1) can be a pulse pair where the first pulse 402 has a given magnitude (as denoted by the vertical axis for light intensity) and the second pulse 404 has a different given magnitude (where the first pulse 402 has a larger magnitude than the second pulse 404). We can denote the ratio of the magnitudes of pulse 402 to pulse 404 as R1. Meanwhile, the channel-specific light signal 116 (for Channel C7) can be a pulse pair where the first pulse 406 has a given magnitude (as denoted by the vertical axis for light intensity) and the second pulse 408 has a different given magnitude (where the second pulse 408 has a larger magnitude than the first pulse 406). We can denote the ratio of the magnitudes of pulse 406 to pulse 408 as R7.

Thus, it can be seen that the pulse magnitude ratio of R1 can be used to encode channel C1 into the pulse sequence for light signal 112, and the pulse magnitude ratio of R7 can be used to encode channel C7 into the pulse sequence for light signal 116.

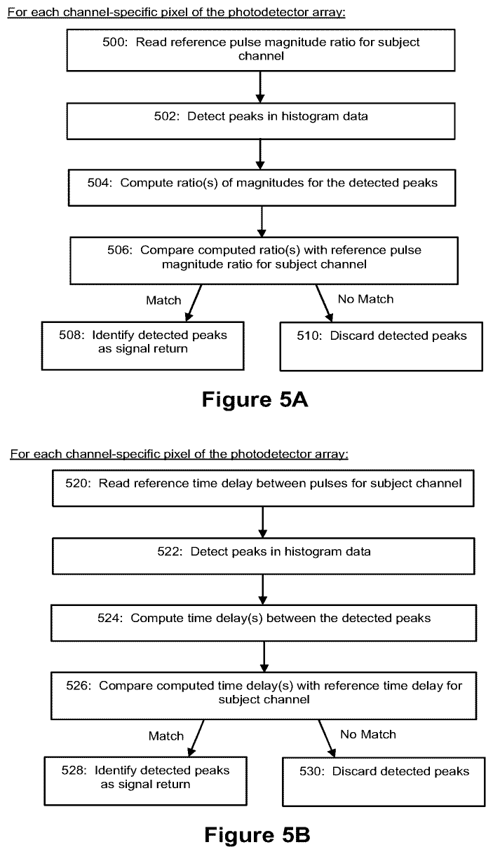

FIG. 5A depicts an example process flow for decoding and processing photodetection signals 120 by a pixel 110 in a given channel 106 using the channel information encoded as per FIG. 4A in order to reduce the presence of out-of-channel noise. In this example, the channel-specific light signal can be a pulse pair whose pulse magnitude ratio identifies the subject channel 106, and the photodetection signals 120 for the subject channel can be manifested as histogram data for the subject channel, where each bin of the histogram includes a count of photon detections that occurred during the collection windows of the laser cycles for the subject pixel 110 of the subject channel 106. The same histogram can be used to collect counts for returns from both pulses of the pulse pair. The signal processing circuitry can keep bintime for the histogramming operations by starting the time count based on the transmission of the first pulse of the pulse pair. However, it should be understood that the signal processing circuitry could generate separate histograms that are keyed to the different pulses of the pulse pair if desired by a practitioner.

At step 500, the signal processing circuitry for the pixel 110 reads the reference pulse magnitude ratio for the subject channel 106. This reference pulse magnitude ratio can be defined by control circuit 124 to govern the channel encoding used by the lidar transmitter 122 for the subject channel 106.

At step 502, the signal processing circuitry detects peaks in the histogram data produced by the pixel 110. This can be accomplished by comparing the bin magnitudes to a noise level for the histogram using a signal to noise threshold. If a bin magnitude exceeds the noise level by an amount equal to or greater than the signal to noise threshold, then the bin can be declared as a detected peak. These detected peaks can then serve as candidate peaks to be considered for classification as a return from the transmitted pulse pair. At step 504, the signal processing circuitry computes the ratio(s) of the magnitudes for the detected peaks. If there are more than two detected peaks in the histogram data, the signal processing circuitry can compute the ratios of the magnitudes for all permutations of the detected peaks that are under consideration as candidates for returns from the transmitted pulse pair. To help mitigate potential ambiguity, a practitioner can choose suitable values for the pulse separation between the pulses of the pulse pair. For example, if the pulse pair is too far apart (e.g., a large pulse separation value) and there are two or more objects in the same channel at different ranges (where the distance between them is less than the distance corresponding to the pulse separation value), then the signal processing circuitry would need to employ extra logic for deconflicting the timing. It would be desirable to avoid such complexity; and empirical experimentation and/or radiometric analysis with different pulse separation values can help reduce the need for such deconfliction.

At step 506, the signal processing circuitry compares the computed pulse magnitude ratio(s) from step 504 with the reference pulse magnitude ratio that was read at step 500. If a pair of detected peaks exhibits a computed pulse magnitude ratio that is deemed a match to the reference pulse magnitude ratio, then this pair of detected peaks can be identified as a signal return from the transmitted pulse pair for the subject channel (see step 508). Step 508 can also be made contingent on the signal processing circuitry determining that the detected peaks are separated by a number of bins corresponding to the time delay(s) between pulses of the transmitted pulse sequence. For any pairs of detected peaks whose computed pulse magnitude ratios are not deemed a match to the reference pulse magnitude ratio, such mismatching pulse pairs can be discarded (see step 510). Detected peaks may also be discarded if they are separated from each other by too few bins or too many bins relative to the time delay(s) between pulses of the transmitted pulse sequence. In this fashion, steps 504, 506, 508, and 510 can operate in combination to filter out-of-channel noise from the photodetection signals 120 for the subject channel 106 because peak pairs that exist in the histogram data that do not exhibit the reference pulse magnitude ratio can be identified and treated as noise. It should be understood that the comparison/matching step 506 can employ a tolerance that allows some defined level of mismatch to exist between the computed ratio and the reference pulse magnitude ratio while still being considered a match (e.g., a 10% tolerance). By employing such a tolerance, margins can be provided to account for measurement noise, and the risk of false negatives can be reduced.

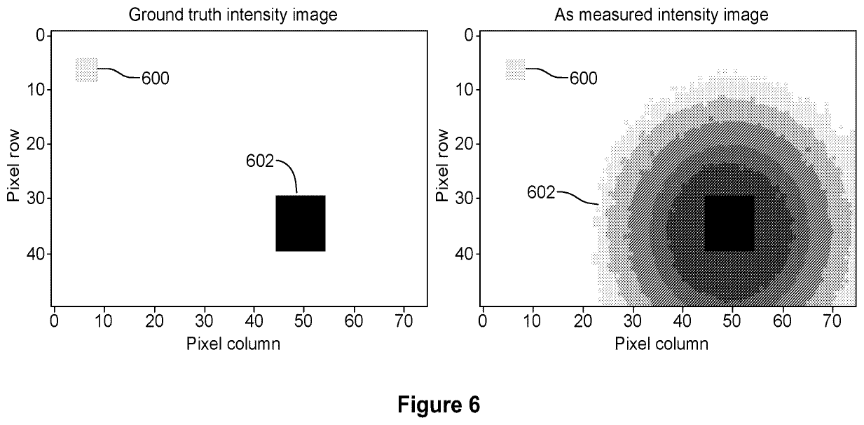

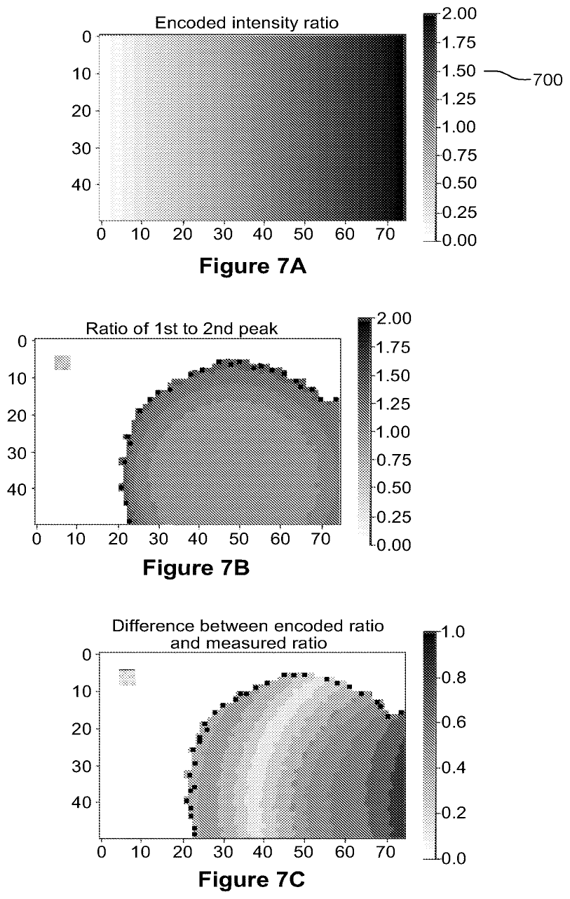

FIGS. 6 and 7A-7D show an example of a simulation of a SPAD-based flash lidar system that encodes channel information into the channel-specific light signals using modulated pulse magnitude ratios. The left frame of FIG. 6 shows a simulated ground truth intensity image of two objects 600 and 602 in a scene (where the vertical axis denotes a pixel row value and where the horizontal axis denotes a pixel column value). Object 600 is a small, dim object (e.g., a Lambertian reflector such as a tree or person); and object 602 is a moderately larger but very bright or highly reflective object (e.g., a specular reflector or retro-reflector such as a stop sign). The right frame of FIG. 6 shows a simulated measured intensity image of objects 600 and 602 in the scene (where no filtering has been employed to reduce the effects of out-of-channel noise). This simulation shows that object 602 manifests itself in the measurement with a large amount of optical glare (see the large halo around object 602 in the right frame of FIG. 6).

To reduce this optical glare, the lidar transmitter 122 can encode azimuth information for the channels 106 via the intensity (pulse magnitude) ratio of a pulse pair in the channel-specific light signals. The pulses of the pulse pair can be separated in time by a sufficiently long period that the SPADs 202 of the pixels 110 can detect and count both pulses of the pulse pair. The typical recovery time of a SPAD is a few nanoseconds, so in an example embodiment, the pulses of the pulse pair might be separated by 10-20 nanoseconds; but it should be understood that a practitioner may choose to employ longer or shorter separations between the pulses of the pulse pairs. FIG. 7A shows a plot of how the intensity (pulse magnitude) ratio can be varied by channel for the simulation (see ratio legend 700). In this example, the intensity (pulse magnitude) ratio varies smoothly from left to right across the scene (where the vertical axis denotes a pixel row value and where the horizontal axis denotes a pixel column value). Furthermore, it can be seen from this example that the elevation angle for a given channel is not encoded into the pulse pair, so different channels that share the same azimuth angle but differ in their elevation angles will employ pulse pairs with the same intensity (pulse magnitude) ratio.

The simulation can then employ the FIG. 5A process flow to extract intensity (pulse magnitude) ratios from the measured data (and these extracted intensity (pulse magnitude) ratios can be used to filter the results during signal processing). For example, a peak detection algorithm was used on the simulated digital histogram data. Because two pulses were emitted, the signal processing looks for both pulses and compares the ratio of the two detected peak magnitudes. FIG. 7B shows a plot of these measured ratios.

In an example embodiment, the difference between the encoded intensity ratio (see FIG. 7A) and the measured intensity ratio (see FIG. 7B) can be used to filter the results for each SPAD-based pixel 110. In this example, the encoded intensity ratio serves as the reference pulse magnitude ratio, and the measured intensity ratio serves as the measured pulse magnitude ratio. The encoded and measured pulse magnitude ratios for each SPAD-based pixel 110 can be compared to evaluate whether they are sufficiently similar. For example, the signal processing circuitry can compute a difference between the encoded (reference) and measured pulse magnitude ratios for each pixel (see FIG. 7C). Any pair of peaks whose measured ratio is not close enough to the encoded (reference) pulse magnitude ratio for the subject channel can be deemed a CMFP, and the CMFPs can be deleted or ignored. In an example embodiment, the filtering can be achieved by requiring the measured pulse magnitude ratio to be within some threshold value of the encoded/reference pulse magnitude ratio. For example, if the measured pulse magnitude ratio was 2.2 and the encoded/reference pulse magnitude ratio was 2.0, then the ratio of the measured pulse magnitude ratio to the encoded/reference pulse magnitude ratio would be 1.1. This ratio of ratios can be referred to as a pattern similarity. If the acceptance range threshold were set such that any peak pair with a pattern similarity less than or equal to 1.1 and greater than or equal to 0.9, then the measured pattern similarity value of 1.1 would be accepted and the peak pair would be deemed a signal return. However, if the acceptance range threshold was made more aggressive to filter more of the halo, then the acceptance range could be made smaller. For example, if the acceptance range threshold for pattern similarity were a value less than or equal to 1.05 and greater than or equal to 0.95, then the measured pattern similarity of 1.1 would result in the peak pair being deemed noise and filtered out. Practitioners can empirically experiment with suitable values for the acceptance range thresholds to find a desirable balance between false positives and false negatives.

FIG. 7D shows the results of this simulation, where the top row of FIG. 7D shows object location images and where the bottom row of FIG. 7D shows intensity images.

The left portion of FIG. 7D shows ground truth object location and intensity images which correspond to the scene of FIG. 6. The middle portion of FIG. 7D shows measured object location and intensity images which correspond to the scene of FIG. 6. The right portion of FIG. 7D shows the filtered object location and intensity images which correspond to the scene of FIG. 6. For this example, the filtering was performed so that the measured pattern similarity was tested against an acceptance range threshold of 0.85 for the lower threshold and 1.15 for the upper threshold. Furthermore, to detect peaks in the histogram data above the noise, a signal to noise threshold of 6 was used. As shown by the right portion of FIG. 7D, the filtering that is performed on the basis of the differences from FIG. 7C indicates that most of the optical glare/halo would be correctly thrown away using the encoding of FIG. 7A and the filtering approach based on FIGS. 7B and 7C. While some of the optical glare/halo remains, it is expected that further improvements can be achieved through techniques such as also encoding elevation angle in the pulses, adding more pulses to the pulse sequence, or other techniques which would provide the system with more information that can be used to decode the measured signals. Moreover, more intelligent parsing of the intensity information could be employed to provide for better inferencing about whether a point originates from a real object at the subject channel. For example, SPADs and other photodetectors tend to have nonlinearity, which causes the intensity information to become slightly distorted as the photon flux increases. This deviation away from linearity causes the measured pulse magnitude ratio to not be identical to the reference pulse magnitude ratio. To reduce this distortion, the signal processing circuitry could linearize the intensity values before calculating the pulse magnitude ratios, which would improve the efficacy of the filtering process. This can be accomplished by modeling the nonlinearity and creating a lookup table that takes the distorted signal as an input and (approximately) returns the undistorted signal as an output before forming ratios.

### Encoding Channel Information in Light Signals by Modulating Times Between Pulses

As a second encoding example, the channel-specific light signal can comprise a pulse sequence of two or more pulses, and the channel information can be encoded in the light signal by varying the times between pulses of the pulse sequence. For example, the lidar transmitter 122 can modulate the time delay between the pulses in the pulse sequence so that there are differences among the channels 106 with respect to the time delays between the pulses. In this fashion, different time delays can be used to denote different channels 106.

In the examples discussed below where channel information is encoded in the pulse sequence by varying the time between the pulses, the pulse sequence is a pulse pair (a sequence of 2 pulses). However, it should be understood that the techniques discussed below can be readily extended to longer pulses sequences (e.g., pulse trains of 3 or more pulses). An example of encoding channel information in pulse pairs is shown by FIG. 4B. In this example, channel-specific light signal 112 (for Channel C1) can be a pulse pair where the first pulse 402 is separated from the second pulse 404 by a time delay of d1. Meanwhile, the channel-specific light signal 116 (for Channel C7) can be a pulse pair where the first pulse 406 is separated by the second pulse 408 by a time delay of d7. Similarly, the channel-specific light signal 410 (for a given channel Cn) can be a pulse pair where the first pulse 412 is separated from the second pulse 414 by a time delay of dn. Thus, it can be seen that the delay d1 can be used to encode channel C1 into the pulse sequence for light signal 112, the delay d7 can be used to encode channel encode channel C7 into the pulse sequence for light signal 116, and the delay dn can be used to encode channel Cn into the pulse sequence for light signal 410.

FIG. 5B depicts an example process flow for decoding and processing photodetection signals 120 by a pixel 110 in a given channel 106 using the channel information encoded as per FIG. 4B in order to reduce the presence of out-of-channel noise. In this example, the channel-specific light signal can be a pulse pair whose time between pulses identifies the subject channel 106, and the photodetection signals 120 for the subject channel can be manifested as histogram data for the subject channel, where each bin of the histogram includes a count of photon detections that occurred during the collection windows of the laser cycles for the subject pixel 110 of the subject channel 106. The same histogram can be used to accumulate returns from the pulse pair, in which case it is expected that the histogram will exhibit two peaks whose bin separation in the histogram generally corresponds to the channel-specific time delay between pulses of the pulse pair for that channel. The signal processing circuitry can keep bintime for the histogramming operations by starting the time count based on the transmission of the first pulse of the pulse pair. However, it should be understood that the signal processing circuitry could generate separate histograms that are keyed to the different pulses of the pulse pair if desired by a practitioner.

At step 520, the signal processing circuitry for the pixel 110 reads the reference time delay between pulses for the subject channel 106. This reference time delay can be defined by control circuit 124 to govern the channel encoding used by the lidar transmitter 122 for the subject channel 106.

At step 522, the signal processing circuitry detects peaks in the histogram data produced by the pixel 110. This can be accomplished by comparing the bin magnitudes to a noise level for the histogram using a signal to noise threshold. These detected peaks can then serve as candidate peaks to be considered for classification as a return from the transmitted pulse pair. If a bin magnitude exceeds the noise level by an amount equal to or greater than the signal to noise threshold, then the bin can be declared as a detected peak. At step 524, the signal processing circuitry computes the time delay(s) between the detected peaks. As an example, this time delay can be represented by and/or computed from a bin distance between the bins that hold the detected peaks. For example, the bins can have known bin widths that correspond to the time periods covered by the bins, and the bin distances can thus reflect the time between the detected peaks. If there are more than two detected peaks in the histogram data, the signal processing circuitry can compute the time delays between all permutations of the detected peaks that are under consideration as candidates for returns from the transmitted pulse pair. As noted above, a practitioner may want to choose the time delays for encoding the channel information in a manner that would reduce potential ambiguity issues (based on frame-to-frame coincidence and/or prior environmental factors) and simplify the signal processing circuitry.

At step 526, the signal processing circuitry compares the computed time delay(s) from step 524 with the reference time delay that was read at step 520. If the computed time delay between a pair of detected peaks is deemed a match to the reference time delay, then this pair of detected peaks can be identified as a signal return from the transmitted pulse pair for the subject channel (see step 528). For any pairs of detected peaks whose time delays that are not deemed a match to the reference time delay, such mismatching pulse pairs can be discarded (see step 530). In this fashion, steps 524, 526, 528, and 530 can operate in combination to filter out-of-channel noise from the photodetection signals 120 for the subject channel 106 because peak pairs that exist in the histogram data that do not exhibit the reference time delay between peak pairs can be identified and treated as noise. It should be understood that the comparison/matching step 526 can employ a tolerance that allows some defined level of mismatch to exist between the computed time delay and the reference time delay while still being considered a match (e.g., a 10% tolerance). By employing such a tolerance, margins can be provided to account for measurement noise, and the risk of false negatives can be reduced.

It should be understood that the process flows of FIGS. 5A and 5B can be performed for each pixel 110 of the photodetector array 108. Moreover, the signal processing circuit 132 can be configured to perform the FIGS. 5A and 5B process flows in parallel for each pixel 110. To support such parallelization, the signal processing circuit can include a processor and memory that support such parallelized operations. For example, the processor may take the form of an application-specific integrated circuit (ASIC) and/or field programmable gate array (FPGA) that includes parallelized hardware logic that can be configured to carry out steps 500-510 and/or 520-530 in parallel for the different channels. However, it should be understood that software-based compute resources that are capable of carrying out parallelized operations (e.g., multi-core processors) may also be employed by the signal processing circuit 132 to implement the process flows of FIGS. 5A and/or 5B in parallel for each channel.

It should also be understood that the FIGS. 5A and 5B process flows are just examples of the filtering techniques that can be used to leverage the channel encoding to filter out-of-channel noise. For example, as an alternative approach to filtering, a computation can be performed to determine the channel(s) and corresponding channel encodings for highly reflective or bright objects in the scene (e.g., retroreflectors). Next, any signals measured in other channels but which contain the determined channel encoding(s) for the highly reflective or bright object can be thrown out.

Further still, it should be understood that the channel information can be encoded in the transmitted pulse sequences via both pulse magnitude ratios for the pulses and the time delays between pulses if desired by a practitioner.

### Encoding Channel Information in Light Signals by Randomizing Transmission Times for Pulses

As a third encoding example, channel information can be encoded in the channel-specific light signals through randomization of their transmission times. The pixels 110 corresponding to the channels 106 can then synchronize their collection windows with the randomized transmission times for the channel-specific light signals corresponding to those channels 106. With this approach, out-of-channel noise arriving at a pixel 110 would appear as being part of ambient, uncorrelated, background light because such out-of-channel noise would not be correlated with the randomized transmission schedule for the in-channel channel-specific light signals of the subject channel (due to the other channels having their own randomized transmission schedule for channel-specific light signals). Accordingly, by synchronizing the channel-specific collection windows with the channel-specific light signals, the signal returns from in-channel objects will be naturally correlated with the randomized in-channel transmission times, while the out-of-channel noise will be uncorrelated to the randomized in-channel transmission times. This will have the effect of naturally filtering out-of-channel noise to improve the detection of signal returns within the photodetection signals 120.

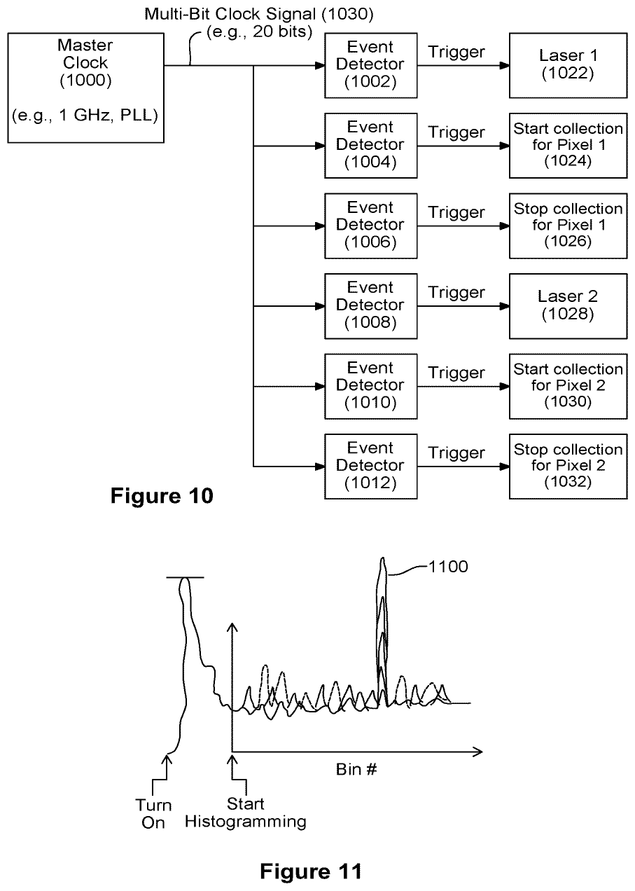

For example, with reference to FIG. 3, the array of light emitters 310 can be driven so that different emitters 310 are turned on separately on their own randomized schedule of transmissions for the cycles of a lidar frame. The pixels 310 corresponding to each emitter 310 can synchronize their collection windows to the randomized transmission schedule of their corresponding emitters 310. With this approach, returns from an object located in the subject channel 106 will correlate with the randomized transmission times for the channel-specific light signals of the subject channel 106 and manifest as large peaks in the histogram data (e.g., see FIG. 11 (peak 1100)). By contrast, out-of-channel noise that corresponds to returns from objects located outside the subject channel 106 will appear as ambient light because the returns from those objects will be spread over the subject channel's histogram rather than concentrated in a particular bin (because of the randomized transmission schedules outside the subject channel 106).

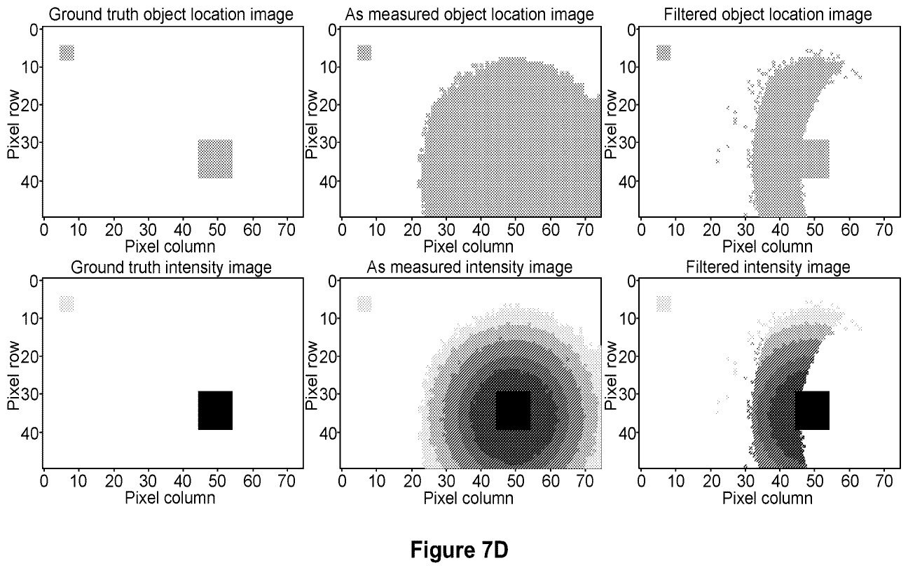

FIG. 8A depicts an example process flow for implementing this randomization approach to channel encoding. At step 800, a randomized sequence of transmission times is generated for a subject channel 106. This randomized sequence of transmission times can be a vector of time values ({t(1), t(2), t(3), . . . }, where each time value defines a transmission time within a cycle of a lidar frame, and where the time values are randomly defined using random number generation (RNG) techniques. This randomized timing sequence can be generated by a component of the system 100 such as control circuit 124, or it can be generated on-board the transmitter 122 and/or receiver 102 with quasi-random number generation and a shared seed. In another example, the randomized timing sequence can be generated by some other component outside the lidar system. At step 802, the randomized timing sequence for the subject channel is shared with the transmitter 122 and/or receiver 102 as necessary so that the transmitter 122 and receiver 102 can synchronize their respective operations. At step 804, the lidar transmitter 122 transmits pulses into the subject channel at times corresponding to the randomized timing sequence defined for that channel. At step 806, the lidar receiver 102 synchronizes its collections from the subject channel according to the randomized transmission schedule of the lidar transmitter 122 for the subject channel.

The steps of FIG. 8A can be performed for each channel 106, which will have the effect of creating and implementing transmission schedules for the channel-specific light signals of the different channels 106 that randomly vary relative to each other.

FIG. 8B depicts an example timeline that illustrates the nature of the randomized time shifts between transmission schedules for different channels 106 and the synchronization of channel-specific collection windows with the randomized transmission schedules. The horizonal axis of FIG. 8B represents time. For ease of illustration, FIG. 8B shows a timeline of two cycles of a lidar frame; although it should be understood that a lidar frame will include many more cycles of light transmissions. For example, the number of cycles per lidar frame may be a value ranging from 10 (or less) to 100,000 (or more), where the number of cycles is commonly a value in a range between 100 and 10,000.

Within each cycle, the light emitters 310 corresponding to the different channels 106 will emit their light signals at randomized times. The pixels 110 corresponding to those channels 106 will then synchronize their collection windows based on when their corresponding emitters 310 transmit light. For example, FIG. 8B shows that for “Cycle 1”, pulse 850 for Channel 1 is emitted early in the cycle; followed by the transmission of pulse 852 for Channel 2, and so on (including pulse 854 for Channel n). The transmission times for each channel's pulse of the first cycle can be defined by the random t(1) values generated at step 800 for each of the channels 106. The collection window 870 for {Cycle 1, Channel 1} can then be synchronized to the transmission time of pulse 850. For example, collection window 870 can start when pulse 850 is fired (or shortly thereafter). Likewise, the collection window 872 for {Cycle 1, Channel 2} can be synchronized to the transmission time of pulse 852; and the collection window 874 for {Cycle 1, Channel n} can be synchronized to the transmission time of pulse 854. During the next cycle (Cycle 2), each emitter 310 will emits its light signal at the random t(2) values defined by the randomized timing schedule from step 800 for the each of the channels 106. In the example of FIG. 8B, the pulse 856 for {Cycle 2, Channel 2} will precede the pulses 858 and 860 for {Cycle 2, Channel n} and {Cycle 2, Channel 1} respectively. Moreover, for Cycle 2, the pulse 858 for Channel n will precede the pulse 860 for Channel 1. The collection window 876 for {Cycle 2, Channel 2} can then be synchronized to the transmission time of pulse 856. Likewise, the collection window 878 for {Cycle 2, Channel n} can be synchronized to the transmission time of pulse 858; and the collection window 880 for {Cycle 2, Channel 1} can be synchronized to the transmission time of pulse 860.

Accordingly, it should be understood from FIG. 8B that there will be a randomized temporal shift between the transmission times for pulses of different channels by the lidar transmitter 122 with respect to the different cycles of the lidar frame. Moreover, by synchronizing each channel's collection windows based on these randomized transmission times, it should be appreciated that, over a number of cycles, returns from in-channel objects will accumulate in a common bin while returns from out-of-channel objects (or other out-of-channel sources of noise/interference) will be randomly spread across different bins because of the lack of temporal synchronization for such out-of-channel returns and the channel's collection windows. FIG. 11 shows an example of how repeating the process of FIGS. 8A and 8B over many cycles (e.g., hundreds of cycles) to build up event histograms would cause any cross-talk to be spread out in time and thus mimic ambient light. FIG. 11 also shows a settling time at the beginning of each histogram collection window (which can be tens of nanoseconds before the SPAD of the subject pixel 110 stabilizes). It should be understood that while this settling time is desirable, a practitioner may choose to omit it.

For ease of illustration, FIG. 8B does not show the transmission times for the pulses of the other channels of the lidar system 100; but it should be understood that each cycle would also include randomized transmission times for the pulses of other channels. Also, the system could employ a transmission downtime between cycles that allows for the generation or sharing of the randomized transmission times as between the receiver 102 and transmitter 122 if necessary.

It can also be appreciated from FIG. 8B that the duration of each cycle will need to be longer than the collection window for any individual channel's histogram. But, given that overlaps are permitted between the collection windows of different channels within the same cycle, the total time duration for a cycle need not be the sum of the collection windows needed for each channel. For example, if we assume that each collection window has a duration of 200 nanoseconds (which would accommodate a 30 meter maximum detection range), and if we assume there are 16 channels (for our simplified example), the duration of each cycle need not be 16*200 nanoseconds (3.2 microseconds). For example, the cycles could have shorter durations such as 2 microseconds because a practitioner may choose to permit some degrees of overlap between the collection windows of different channels within a cycle.

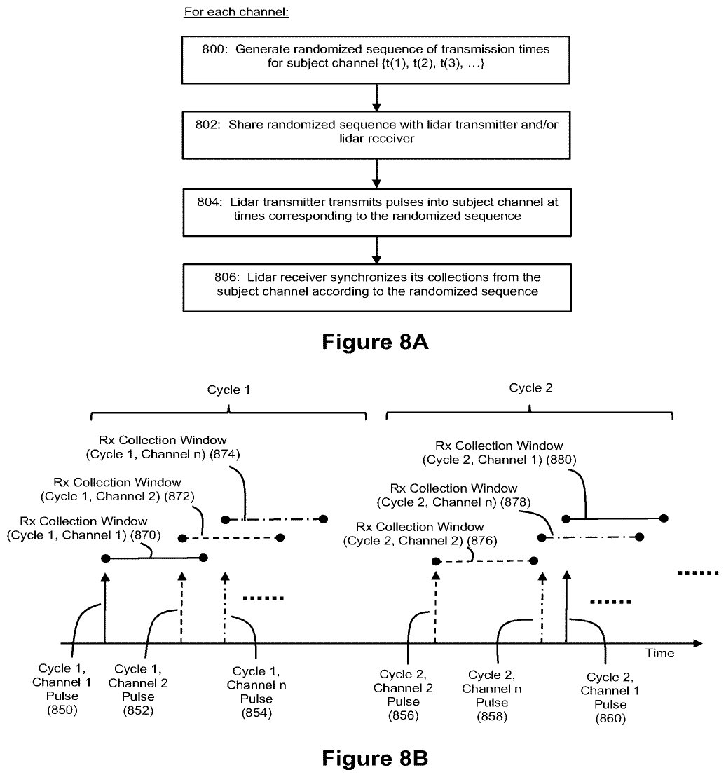

FIG. 9 shows an example process flow for carrying out return detection using SPAD-based pixels 110 when randomized transmission times are used for different channels to encode channel information in the channel-specific light signals. At step 902, the emitter 310 for a subject channel transmits a light pulse at a randomized time. At step 904, the pixel 110 for the subject channel starts its collection window. During this collection window, the pixel 110 for the subject channel populates the subject channel's histogram based on detection(s) by the SPAD(s) of that pixel 110. At step 908, the collection window for the subject channel ends. At step 910, a determination is made as to whether there are any additional cycles left for the lidar frame. If yes, the process flow returns to step 902 (where the next pulse is transmitted for the next cycle at a randomized time). If no, this means that all of the cycles for the lidar frame have been completed, and the process flow can proceed to step 912. This iterative nature of steps 902-910 allows for the subject channel's histogram to be populated with detections over a large number of laser cycles (where the transmission times of pulses within the cycles will be randomly varying from cycle to cycle).

At step 912, the signal processing circuit 132 reads the histogram data for the subject channel. At step 914, the signal processing circuit 132 processes this histogram data to detect any peak(s) that are present. As noted above, this can be accomplished by comparing the bin magnitudes to a noise level for the histogram using a signal to noise threshold. If a bin magnitude exceeds the noise level by an amount equal to or greater than the signal to noise threshold, then the bin can be declared as a detected peak. Moreover, because the synchronization of the histogram collection windows with the randomized pulse transmission times operates to naturally correlate the peaks with the transmitted pulses, the histogram collection process combined with peak detection at step 914 operates to filter out out-of-channel noise; so any peaks detected at step 914 can be identified as a signal return from an object that is located in the subject channel (see step 916). If no peaks are detected at step 914, the histogram can be deemed to contain only out-of-channel noise (see step 918).

The FIG. 9 process flow can be performed for each channel of the system 100, and the signal processing circuit 132 can be configured to carry out steps 912-918 in parallel for each channel. To support such parallelization, the signal processing circuit can include a processor and memory that support such parallelized operations. For example, the processor may take the form of an application-specific integrated circuit (ASIC) and/or field programmable gate array (FPGA) that includes parallelized hardware logic that can be configured to carry out steps 912-918 in parallel for the different channels. However, it should be understood that software-based compute resources that are capable of carrying out parallelized operations (e.g., multi-core processors) may also be employed by the signal processing circuit 132 to implement the FIG. 9 process flow in parallel for each channel.

By using randomized transmission times to encode channel information in the channel-specific light signals rather than modulating the channel-specific light signals themselves as discussed above, a number of advantages can be achieved. For example, the FIG. 9 approach needs significantly less additional post-processing of histogram data than would be needed for the approaches of FIGS. 5A and 5B. Moreover, by using randomized transmission times to encode channel information in the channel-specific light signals rather than modulating the channel-specific light signals themselves as discussed above, it is expected that the risk of inadvertently discarding true returns (the false negative risk) would be greatly reduced.

Further still, the rejection power to off-code signals would be dramatically higher with the randomized transmission time approach than with the pulse modulation approach. That is to say, if the system sends (for example) 1,000 pulses per frame where each pulse is transmitted at a randomized time within its cycle, we would effectively have a 1,000 sample “code” for the subject channel where the noise is randomly spread across all bins of this histogram, which provides the system with a rejection proportional to the number of shots taken per frame rather than the (much smaller) rejection arising from aligning two samples (for examples where channel information is encoded in a pulse pair) with respect respective amplitude code and/or time delay code. Accordingly, the randomized transmission time approach to encoding channel information in pulses can be particularly useful for scenarios where the source of noise/interference is very strong (such as an interfering nearby lidar system). The issue with such interfering signal is that they can be very strong and also contain the same general frequency spectrum. If the system only tries to filter out such interference using post-processing techniques (such as those described in connection with FIGS. 4A and 4B), then there will be a risk that the filtering will operate less than optimally when the interference becomes so strong that the receiver gets saturated (in which case the intensity information may become meaningless) or that the receiver is blinded to real objects. But, with the randomized timing approach of FIG. 8A, the strong interference would be spread randomly across the bins to greatly reduce its impact so that it looks like uncorrelated background light (e.g., sunlight).

A clock signal can be used to synchronize the lidar transmitter 122 with the lidar receiver 102 for aligning the collection windows with the randomized transmission times for the light pulses. This synchronization may include both (1) the timing of the clock edges driving the transmitter 122 and receiver 102 to accomplish high accuracy ranging (e.g., a 1 GHz clock with ˜few picosecond precision on the rising edge) and (2) the sequencing of the channels (e.g., on what clock cycle to fire each laser pulse aimed at each channel and what clock cycle to begin collecting histogram data for each channel).

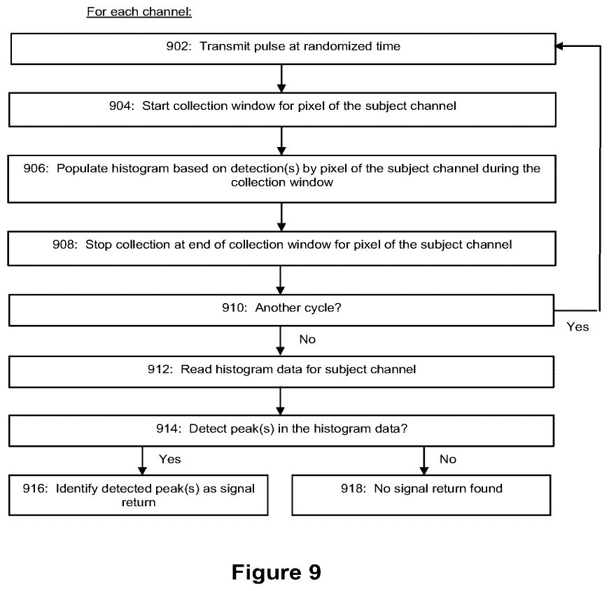

In an example embodiment, high speed clock synchronization between the transmitter 122 and receiver 102 can be achieved with a single shared synchronization signal. An example of such a shared synchronization signal is shown by FIG. 10. With the example of FIG. 10, there is a master clock 1000. This master clock 1000 can be a 1 GHz master clock on a phase-lock-loop (PLL), and it can generate a multi-bit digital clock signal 1030 (e.g., a 20-bit clock signal). Event detectors for different components of the system 100 can be loaded with defined clock times at which their corresponding components are supposed to be triggered according to the system's synchronization. For example event detector 1002 can be a trigger for “Laser 1” (see 1022) (which can be one of the emitters 310 of the light source array 128). If we assume that Laser 1 is the emitter for Channel 1, then event detector 1002 can be loaded with trigger clock values that correspond to the defined randomized transmission times from step 800 for Channel 1. When event detector 1002 detects that the clock signal 1030 matches its trigger clock value, then event detector 1002 can trigger Laser 1 to emits its pulse toward Channel 1. Similarly, event detectors 1004 and 1006 can be loaded with trigger clock values that define when Pixel 1 (for Channel 1) will start and stop its collection window for detecting returns from the pulse fired by Laser 1 (see 1024 and 1026 in FIG. 10). Event detectors 1008, 1010, and 1012 can perform like functions for Channel 2 with respect to Laser 2 (see 1028) and the start/stop times for the collection window on Channel 2 (see 1030 and 1032).

While the invention has been described above in relation to its example embodiments, various modifications may be made thereto that still fall within the invention's scope.

For example, the channel-specific randomized transmission time technique can be employed with a scanning lidar system if desired by a practitioner, where multiple shots targeting fixed locations can be randomly spaced in time.

As another example, some practitioners may choose to combine multiple modes of channel encoding as described herein in the same lidar system. For example, channel encoding could employ any combination of two or more of channel-specific pulse magnitude ratios, channel-specific inter-pulse delays, and channel-specific randomized transmission times. Similarly, a lidar system can be designed to be switchable between any combination of these modes of channel encoding (e.g., switching from operating on a channel-specific pulse magnitude ratio basis to a channel-specific inter-pulse delay basis, switching from operation on a channel-specific randomized transmission time basis to a channel-specific inter-pulse delay basis, etc.).

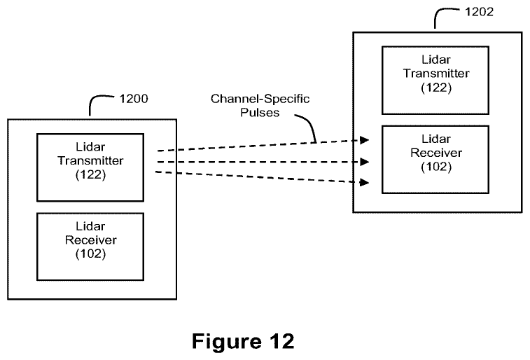

As another example the lidar transmitter 122 can be physically distant from the lidar receiver 102. With such a distributed system, the separated lidar receiver 102 and lidar transmitter 122 can be tuned into each other by sharing the channel encodings (where, as noted above, such channel encoding can be achieved by techniques such as channel-specific pulse magnitude ratios, channel-specific inter-pulse delays, channel-specific randomized transmission times). An example of such a distributed system is shown by FIG. 12. In this example, the distributed lidar system comprises two discrete lidar systems 1200 and 1202, each with their own lidar receiver 102 and lidar transmitter 122.

As yet another example, it should be noted that the lidar transmitter 122 can use the channel-specific encodings such as multiple randomly timed pulses chosen from two or more preselected random timings to encode bits of data (ones and zeros), and the lidar receiver 122 could determine which of the preselected random timings was transmitted by correlating received signals with the preselected random timings using thresholds. By doing this the lidar transmitter 122 can send messages to the lidar receiver 102. This could be useful for implementing messaging backchannels between distributed lidar systems. As an example, a shared seed can be used by the distributed lidar systems to establish mutually known coding.

Accordingly, a number of example embodiments are described herein such as those listed below.
Embodiment A1. A lidar system comprising:
   a lidar transmitter that transmits channel-specific light signals into a plurality of channels within a field of view, wherein the channel-specific light signals have corresponding channels to which they are transmitted and encode channel information for their corresponding channels; and
   a lidar receiver, the lidar receiver comprising a plurality of channel-specific photodetectors, wherein the channel-specific photodetectors have corresponding channels within the field of view;
   wherein the lidar receiver (1) senses incident light via a plurality of the channel-specific photodetectors, (2) produces channel-specific photodetection signals based on the incident light sensed by the channel-specific photodetectors, wherein the channel-specific photodetection signals include out-of-channel noise, and (3) filters the channel-specific photodetection signals based on the encoded channel information for their corresponding channels to reduce the out-of-channel noise.
Embodiment A2. The system of Embodiment A1 wherein the lidar receiver detects returns from the channel-specific light signals based on the filtered channel-specific photodetection signals.
Embodiment A3. The system of Embodiment A2 wherein the lidar receiver further comprises a signal processing circuit that performs the filter and detect operations.
Embodiment A4. The system of embodiment A3 wherein the signal processing circuit comprises a processor and memory.
Embodiment A5. The system of Embodiment A4 wherein the processor comprises a field programmable gate array (FPGA) and/or application-specific integrated circuit (ASIC).
Embodiment A6. The system of any of Embodiments A1-A5 wherein the channel-specific light signals comprise a plurality of pulses in channel-specific pulse sequences, and wherein the lidar transmitter encodes the channel information in the channel-specific light signals as a function of magnitudes for the pulses of the channel-specific pulse sequences.
Embodiment A7. The system of Embodiment A6 wherein the lidar receiver filters the channel-specific photodetection signals by (1) detecting a plurality of candidate return peaks for pulse sequence returns in the channel-specific photodetection signals and (2) determining whether the detected candidate return peaks correspond to return signals based on magnitude information for the detected candidate return peaks.
Embodiment A8. The system of Embodiment A7 wherein the lidar receiver determines whether the detected candidate return peaks correspond to return signals by, for each of a plurality of channels, (1) determining reference magnitude information for that channel, (2) measuring magnitude information for the detected candidate return peaks for that channel, (3) comparing the determined reference magnitude information for that channel with the measured magnitude information for the detected candidate return peaks for that channel, and (4) rejecting candidate return peaks whose measured magnitude information does not match the reference magnitude information for that channel within a defined tolerance.
Embodiment A9. The system of any of Embodiments A6-A8 wherein the channel information is encoded in the channel-specific pulse sequences as ratios of magnitudes for the pulses in the channel-specific pulse sequences so that different channels are represented by different pulse magnitude ratios.
Embodiment A10. The system of Embodiment A9 wherein the lidar receiver (1) linearizes return pulse magnitudes and (2) computes pulse magnitude ratios based on the linearized return pulse magnitudes.
Embodiment A11. The system of any of Embodiments A1-A10 wherein the channel-specific light signals comprise a plurality of pulses in channel-specific pulse sequences, and wherein the lidar transmitter encodes the channel information in the channel-specific light signals as a function of time delays between the pulses of the channel-specific pulse sequences.
Embodiment A12. The system of Embodiment A11 wherein the lidar receiver filters the channel-specific photodetection signals by (1) detecting a plurality of candidate return peaks for pulse sequence returns in the channel-specific photodetection signals and (2) determining whether the detected candidate return peaks correspond to return signals based on time delay information between the detected candidate return peaks.
Embodiment A13. The system of Embodiment A12 wherein the lidar receiver determines whether the detected candidate return peaks correspond to return signals by, for each of a plurality of channels, (1) determining a reference time delay between pulses for that channel, (2) measuring time delays between the detected candidate return peaks for that channel, (3) comparing the determined reference time delay for that channel with the measured time delays between the detected candidate return peaks for that channel, and (4) rejecting candidate return peaks whose measured time delays therebetween do not match the reference time delay between pulses for that channel within a defined tolerance.
Embodiment A14. The system of any of Embodiments A1-A13 wherein the encoded channel information comprises azimuth angles to which the channel-specific light signals are targeted.
Embodiment A15. The system of any of Embodiments A1-A14 wherein the encoded channel information comprises elevation angles to which the channel-specific light signals are targeted.
Embodiment A16. The system of any of Embodiments A1-A15 wherein the encoded channel information comprises azimuth angles and elevation angles to which the channel-specific light signals are targeted.
Embodiment A17. The system of any of Embodiments A1-A16 wherein the encoded channel information comprises channel-specific randomizations for the channel-specific light signals.
Embodiment A18. The system of Embodiment A17 wherein the channel-specific light signals comprise a plurality of channel-specific pulses, and wherein the channel-specific randomizations comprise randomized transmission times for the channel-specific pulses.
Embodiment A19. The system of Embodiment A18 wherein the randomized transmission times comprise randomized transmission times for the channel-specific pulses over a plurality of cycles within a lidar frame.
Embodiment A20. The system of any of Embodiments A17-A19 wherein the channel-specific randomizations are communicated to the lidar receiver to synchronize the lidar receiver to the channel-specific light signals.
Embodiment A21. The system of any of Embodiments A17-A20 wherein the lidar receiver (1) generates channel-specific histogram data based on the channel-specific photodetection signals and (2) filters the channel-specific photodetection signals based on (i) channel-specific synchronizations of the lidar receiver with transmissions of the channel-specific light signals and (ii) detections of peaks within the channel-specific histogram data.
Embodiment A22. The system of any of Embodiments A1-A21 wherein the lidar transmitter comprises an array of light sources, wherein each light source has a corresponding channel to which it emits light.
Embodiment A23. The system of Embodiment A22 wherein the lidar transmitter further comprises optical elements that direct light from the light sources toward their corresponding channels.
Embodiment A24. The system of Embodiment A23 wherein the optical elements comprise diffractive optical elements.
Embodiment A25. The system of any of Embodiments A23-A24 wherein the optical elements comprise micro-lenses.
Embodiment A26. The system of any of Embodiments A22-A25 wherein the array of light sources comprises a VCSEL array.
Embodiment A27. The system of any of Embodiments A1-A26 wherein the lidar transmitter comprises a flash lidar transmitter that flood illuminates the field of view or a portion thereof with the channel-specific light signals over a plurality of cycles.
Embodiment A28. The system of Embodiment A27 wherein the channel-specific photodetectors comprise single photon avalanche photodetectors (SPADs).
Embodiment A29. The system of any of Embodiments A27-A28 wherein the lidar receiver comprises a plurality of channel-specific histogram circuits, wherein each channel-specific histogram circuit has a corresponding channel and generates channel-specific histogram data that is indicative of time-of-flight (TOF) information for the detected channel-specific returns based on photon detections by the channel-specific photodetector of its corresponding channel.
Embodiment A30. The system of Embodiment A29 wherein the lidar receiver filters the channel-specific photodetection signals by processing the channel-specific histogram data generated by the channel-specific histogram circuits.
Embodiment A31. The system of any of Embodiments A29-A30 wherein the histogram data comprises data that represents a plurality of histogram bins and counts of photodetection detections within the histogram bins, and wherein the lidar receiver determines time delays between peaks in the histogram data based on bin distances between histogram bins whose counts correspond to bin peaks.
Embodiment A32. The system of any of Embodiments A1-A26 wherein the lidar transmitter comprises a scanning lidar transmitter that scans the field of view with the channel-specific light signals.
Embodiment A33. The system of any of Embodiments A1-A32 wherein the channel-specific photodetectors are arranged as a photodetector array so that each channel-specific photodetector has a channel field of view.
Embodiment A34. The system of any of Embodiments A1-A33 wherein the channel-specific photodetectors are organized as a plurality of pixels.
Embodiment A35. The system of Embodiment A34 wherein each of a plurality of pixels corresponds to a different channel, and wherein each pixel comprises one or more of the channel-specific photodetectors.
Embodiment A36. The system of any of Embodiments A1-A35 wherein the lidar receiver computes range information for objects in the field of view based on the detected channel-specific returns.
Embodiment A37. The system of any of embodiments A1-A36 wherein the channels are non-overlapping.
Embodiment A38. The system of any of Embodiments A1-A36 wherein a plurality of the channels are overlapping.
Embodiment A39. The system of any of Embodiments A1-A38 wherein the lidar system comprises a distributed lidar system, wherein the lidar receiver and the lidar transmitter are physically distant from each other.
Embodiment A40. The system of any of Embodiments A1-A39 wherein the lidar transmitter uses the channel-specific light signals to communicate message data to the lidar receiver.
Embodiment A41: The system of any of Embodiments A1-A40 wherein the lidar system is switchable between a plurality of different modes of channel encoding for the channel-specific light signals.
Embodiment B1. A lidar method comprising:
   transmitting channel-specific light signals into a plurality of channels within a field of view, wherein the channel-specific light signals have corresponding channels to which they are transmitted and encode channel information for their corresponding channels;
   sensing incident light via a plurality of channel-specific photodetectors, wherein the channel-specific photodetectors have corresponding channels;
   producing channel-specific photodetection signals based on the incident light sensed by the channel-specific photodetectors, wherein the channel-specific photodetection signals include out-of-channel noise; and
   filtering the channel-specific photodetection signals based on the encoded channel information for their corresponding channels to reduce the out-of-channel noise.
Embodiment B2. The method of Embodiment B1 further comprising:
   detecting returns from the channel-specific light signals based on the filtered channel-specific photodetection signals.
Embodiment B3. The method of Embodiment B2 wherein the filtering and detecting steps are performed by a signal processing circuit.
Embodiment B4. The method of Embodiment B3 wherein the signal processing circuit comprises a processor and memory.
Embodiment B5. The method of Embodiment B4 wherein the processor comprises a field programmable gate array (FPGA) and/or application-specific integrated circuit (ASIC).
Embodiment B6. The method of any of Embodiments B1-B5 wherein the channel-specific light signals comprise a plurality of pulses in channel-specific pulse sequences, the method further comprising:
   encoding the channel information in the channel-specific light signals as a function of magnitudes for the pulses of the channel-specific pulse sequences.
Embodiment B7. The method of Embodiment B6 wherein the filtering step comprises (1) detecting a plurality of candidate return peaks for pulse sequence returns in the channel-specific photodetection signals and (2) determining whether the detected candidate return peaks correspond to return signals based on magnitude information for the detected candidate return peaks.
Embodiment B8. The method of Embodiment B7 wherein the determining step comprises determining whether the detected candidate return peaks correspond to return signals by, for each of a plurality of channels, (1) determining reference magnitude information for that channel, (2) measuring magnitude information for the detected candidate return peaks for that channel, (3) comparing the determined reference magnitude information for that channel with the measured magnitude information for the detected candidate return peaks for that channel, and (4) rejecting candidate return peaks whose measured magnitude information does not match the reference magnitude information for that channel within a defined tolerance.
Embodiment B9. The method of any of Embodiments B6-B8 wherein the encoding step comprises encoding the channel information in the channel-specific pulse sequences as ratios of magnitudes for the pulses in the channel-specific pulse sequences so that different channels are represented by different pulse magnitude ratios.
Embodiment B10. The method of Embodiment B9 further comprising:
   linearizing return pulse magnitudes; and
   computing pulse magnitude ratios based on the linearized return pulse magnitudes.
Embodiment B11. The method of any of Embodiments B1-B10 wherein the channel-specific light signals comprise a plurality of pulses in channel-specific pulse sequences, the method further comprising:
   encoding the channel information in the channel-specific light signals as a function of time delays between the pulses of the channel-specific pulse sequences.
Embodiment B12. The method of Embodiment B11 wherein the filtering step comprises (1) detecting a plurality of candidate return peaks for pulse sequence returns in the channel-specific photodetection signals and (2) determining whether the detected candidate return peaks correspond to return signals based on time delay information between the detected candidate return peaks.
Embodiment B13. The method of Embodiment B12 wherein the determining step comprises determining whether the detected candidate return peaks correspond to return signals by, for each of a plurality of channels, (1) determining a reference time delay between pulses for that channel, (2) measuring time delays between the detected candidate return peaks for that channel, (3) comparing the determined reference time delay for that channel with the measured time delays between the detected candidate return peaks for that channel, and (4) rejecting candidate return peaks whose measured time delays therebetween do not match the reference time delay between pulses for that channel within a defined tolerance.
Embodiment B14. The method of any of Embodiments B1-B13 wherein the encoded channel information comprises azimuth angles to which the channel-specific light signals are targeted.
Embodiment B15. The method of any of Embodiments B1-B14 wherein the encoded channel information comprises elevation angles to which the channel-specific light signals are targeted.
Embodiment B16. The method of any of Embodiments B1-B15 wherein the encoded channel information comprises azimuth angles and elevation angles to which the channel-specific light signals are targeted.
Embodiment B17. The method of any of Embodiments B1-B16 wherein the encoded channel information comprises channel-specific randomizations for the channel-specific light signals.
Embodiment B18. The method of Embodiment B17 wherein the channel-specific light signals comprise a plurality of channel-specific pulses, and wherein the channel-specific randomizations comprise randomized transmission times for the channel-specific pulses.
Embodiment B19. The method of Embodiment B18 wherein the randomized transmission times comprise randomized transmission times for the channel-specific pulses over a plurality of cycles within a lidar frame.
Embodiment B20. The method of any of Embodiments B17-B19 wherein the channel-specific randomizations are communicated to the lidar receiver to synchronize the lidar receiver to the channel-specific light signals.
Embodiment B21. The method of any of Embodiments B17-B20 further comprising:
   generating channel-specific histogram data based on the channel-specific photodetection signals; and
   wherein the filtering step comprises filtering the channel-specific photodetection signals based on (i) channel-specific synchronizations of the lidar receiver with transmissions of the channel-specific light signals and (ii) detections of peaks within the channel-specific histogram data.
Embodiment B22. The method of any of Embodiments B1-B21 wherein the transmitting step is performed by an array of light sources, wherein each light source has a corresponding channel to which it emits light.
Embodiment B23. The method of Embodiment B22 wherein the transmitting step further comprises directing light from the light sources toward their corresponding channels via a plurality of optical elements.
Embodiment B24. The method of Embodiment B23 wherein the optical elements comprise diffractive optical elements.
Embodiment B25. The method of any of Embodiments B23-B24 wherein the optical elements comprise micro-lenses.
Embodiment B26. The method of any of Embodiments B22-B25 wherein the array of light sources comprises a VCSEL array.
Embodiment B27. The method of any of Embodiments B1-B26 wherein the transmitting step comprises flood illuminating the field of view or a portion thereof with the channel-specific light signals over a plurality of cycles.
Embodiment B28. The method of Embodiment B27 wherein the channel-specific photodetectors comprise single photon avalanche photodetectors (SPADs).
Embodiment B29. The method of any of Embodiments B27-B28 further comprising:
   generating channel-specific histogram data that is indicative of time-of-flight (TOF) information for the detected channel-specific returns based on photon detections by the channel-specific photodetector of its corresponding channel.
Embodiment B30. The method of Embodiment B29 wherein the filtering step comprises filtering the channel-specific photodetection signals by processing the channel-specific histogram data.
Embodiment B31. The method of any of Embodiments B29-B30 wherein the histogram data comprises data that represents a plurality of histogram bins and counts of photodetection detections within the histogram bins, the method further comprising:
   detecting time delays between peaks in the histogram data based on bin distances between histogram bins whose counts correspond to bin peaks.
Embodiment B32. The method of any of Embodiments B1-B26 wherein the transmitting step comprises scanning the field of view with the channel-specific light signals to point illuminate the field of view.
Embodiment B33. The method of any of Embodiments B1-B32 wherein the channel-specific photodetectors are arranged as a photodetector array so that each channel-specific photodetector has a channel field of view.
Embodiment B34. The method of any of Embodiments B1-B33 wherein the channel-specific photodetectors are organized as a plurality of pixels.
Embodiment B35. The method of Embodiment B34 wherein each of a plurality of pixels corresponds to a different channel, and wherein each pixel comprises one or more of the channel-specific photodetectors.
Embodiment B36. The method of any of Embodiments B1-B35 further comprising:
   computing range information for objects in the field of view based on the detected channel-specific returns.
Embodiment B37. The method of any of Embodiments B1-B36 wherein the channels are non-overlapping.
Embodiment B38. The method of any of Embodiments B1-B36 wherein a plurality of the channels are overlapping.
Embodiment B39. The method of any of Embodiments B1-B38 wherein transmitting and sensing steps are perform by a lidar transmitter and a lidar receiver respectively, wherein the lidar transmitter and the lidar receiver are physically distant from each other as part of a distributed lidar system.
Embodiment B40. The method of any of Embodiments B1-B39 further comprising:
   communicating message data via the channel-specific light signals.
Embodiment B41: The method of any of Embodiments B1-B40 further comprising switching between a plurality of different modes of channel encoding for the channel-specific light signals.
Embodiment C1. A flash lidar system comprising:
   a lidar receiver that receives and processes incident light from a field of view, wherein the field of view comprises a plurality of channels, the lidar receiver comprising a pixel array, the pixel array comprising a plurality of pixels, wherein the pixels have corresponding channels in the field of view; and
   a lidar transmitter comprising a light source array, the light source array comprising a plurality of light emitters, wherein the light emitters have corresponding channels in the field of view and controllably emit channel-specific pulses of light into their corresponding channels at a plurality of times over a plurality of cycles according to randomized transmission schedules for the channel-specific pulses; and
   wherein the lidar receiver synchronizes channel-specific histogram collection windows for the pixels to the randomized transmission schedules of the channel-specific pulses that are emitted into the pixels'corresponding channels
Embodiment C2. The system of Embodiment C1 wherein the lidar receiver generates channel-specific histogram data based on photon detections by the pixels during the channel-specific histogram collection windows, and wherein the randomized transmission schedules and synchronized channel-specific histogram collection windows operate to randomly spread out-of-channel noise across a plurality of bins within the channel-specific histogram data.
Embodiment C3. The system of Embodiment C2 wherein the lidar receiver processes the channel-specific histogram data to detect returns of the channel-specific pulses from objects located in the channels.
Embodiment C4. The system of Embodiment C3 wherein the lidar receiver detects the returns based on peaks within the channel-specific histogram data.
Embodiment C5. The system of any of Embodiments C3-C4 wherein the lidar receiver comprises a signal processing circuit that processes the channel-specific histogram data to detect returns of the channel-specific pulses from objects located in the channels.
Embodiment C6. The system of Embodiment C5 wherein the signal processing circuit comprises a processor and memory.
Embodiment C7. The system of Embodiment C6 wherein the processor comprises a field programmable gate array (FPGA) and/or application-specific integrated circuit (ASIC).
Embodiment C8. The system of any of Embodiments C2-C7 wherein the channel-specific histogram data comprises a plurality of count values for a plurality of histogram bins, wherein the histogram bins correspond to different time periods within the channel-specific histogram collection windows, and wherein each histogram bin's count value represents a count of photon detections by the pixel of the corresponding channel during the time period corresponding to that histogram bin.
Embodiment C9. The system of Embodiment C8 wherein the lidar receiver detects peaks within the channel-specific histogram data based on a comparison of the count values for the histogram bins with a signal to noise threshold.
Embodiment C10. The system of Embodiment C9 wherein the detected peaks represent returns of channel-specific pulses from objects in the channels.
Embodiment C11. The system of any of Embodiments C2-C10 wherein the lidar receiver comprises a plurality of channel-specific histogram circuits for generating the channel-specific histogram data.
Embodiment C12. The system of any of Embodiments C1-C11 wherein the randomized transmission schedules comprise channel-specific randomized transmission schedules, and wherein the lidar receiver is synchronized with the lidar transmitter so that, per cycle, each channel's histogram collection window is synchronized with randomized transmission times from the channel-specific randomized transmission schedule for the channel-specific pulses which target that channel.
Embodiment C13. The system of any of Embodiments C1-C12 wherein each pixel comprises one or more photodetectors.
Embodiment C14. The system of Embodiment C13 wherein a plurality of the photodetectors comprise single photon avalanche photodetectors (SPADs).
Embodiment C15. The system of any of Embodiments C1-C14 wherein the light source array comprises a VCSEL array.
Embodiment C16. The system of any of Embodiments C1-C15 wherein the randomized transmission schedules comprise, for each channel, a plurality of randomized transmission times, wherein the randomized transmission times randomly spread out transmissions of the channel-specific pulses within the cycles of the channel-specific pulses.
Embodiment C17. The system of any of Embodiments C1-C16 further comprising a control circuit that generates the randomized transmission schedules and shares the randomized transmission schedules with the lidar transmitter and the lidar receiver.
Embodiment C18. The system of any of Embodiments C1-C17 wherein the channel-specific histogram windows are subdivided into a plurality of cycle-specific, channel-specific histogram collection windows, and wherein a plurality of the cycle specific, channel-specific histogram collection windows are overlapping across a plurality of different channels.
Embodiment C19. The system of any of Embodiments C1-C18 further comprising a master clock that generates a clock signal from which operations of the lidar transmitter and lidar receiver are synchronized for the randomized transmission schedules and channel-specific histogram collection windows.
Embodiment C20. The system of Embodiment C19 further comprising a plurality of event detectors that trigger operations by the lidar transmitter and the lidar receiver based on the clock signal.
Embodiment C21. The system of any of Embodiments C17-C20 wherein the master clock employs a phase locked loop to produce a multi-bit clock signal.
Embodiment C22. The system of any of Embodiments C1-C21 wherein the lidar receiver employs a number of cycles per lidar frame that is a value within a range between 10 cycles and 100,000 cycles.
Embodiment C23. The system of any of Embodiments C1-C21 wherein the lidar receiver employs a number of cycles per lidar frame that is a value within a range between 100 cycles and 10,000 cycles.
Embodiment C24. The system of any of Embodiments C1-C23 wherein the synchronized channel-specific histogram collection windows begin after a settle time for photodetectors of the pixels.
Embodiment C25. The system of any of Embodiments C1-C24 wherein the lidar receiver computes range information for at least one object in the field of view based on channel-specific histogram data collected by the lidar receiver during at least one of the channel-specific histogram collection windows.
Embodiment C26. The system of any of Embodiments C1-C25 wherein the lidar system comprises a distributed lidar system, wherein the lidar receiver and the lidar transmitter are physically distant from each other.
Embodiment C27. The system of any of Embodiments C1-C26 wherein the lidar transmitter uses the channel-specific pulses to communicate message data to the lidar receiver.
Embodiment C28. The system of any of Embodiments C1-C27 further comprising any feature or combination of features set forth by any of Embodiments A1-B41.
Embodiment D1. A flash lidar method that operates over a field of view, wherein the field of view comprises a plurality of channels, the method comprising:
   controllably emitting channel-specific pulses of light into corresponding channels at a plurality of times over a plurality of cycles according to randomized transmission schedules for the channel-specific pulses;
   synchronizing channel-specific histogram collection windows for a plurality of channel-specific pixels with the randomized transmission schedules for the channel-specific pulses that are emitted into the channel-specific pixels'corresponding channels; and
   sensing returns of the channel-specific pulses from objects in the field of view via the channel-specific pixels using the synchronized channel-specific histogram collection windows.
Embodiment D2. The method of Embodiment D1 further comprising:
   generating channel-specific histogram data based on photon detections by the channel-specific pixels during the channel-specific histogram collection windows, and wherein the randomized transmission schedules and synchronized channel-specific histogram collection windows operate to randomly spread out-of-channel noise across a plurality of bins within the channel-specific histogram data.
Embodiment D3. The method of Embodiment D2 further comprising:
   processing the channel-specific histogram data to detect returns of the channel-specific pulses from objects located in the channels.
Embodiment D4. The method of Embodiment D3 further comprising:
   detecting the returns based on peaks within the channel-specific histogram data.
Embodiment D5. The method of any of Embodiments D3-D4 wherein the processing step is performed by a signal processing circuit.
Embodiment D6. The method of Embodiment D5 wherein the signal processing circuit comprises a processor and memory.
Embodiment D7. The method of Embodiment D6 wherein the processor comprises a field programmable gate array (FPGA) and/or application-specific integrated circuit (ASIC).
Embodiment D8. The method of any of Embodiments D2-D7 wherein the channel-specific histogram data comprises a plurality of count values for a plurality of histogram bins, wherein the histogram bins correspond to different time periods within the channel-specific histogram collection windows, and wherein each histogram bin's count value represents a count of photon detections by the pixel of the corresponding channel during the time period corresponding to that histogram bin.
Embodiment D9. The method of Embodiment D8 further comprising:
   detecting peaks within the channel-specific histogram data based on a comparison of the count values for the histogram bins with a signal to noise threshold.
Embodiment D10. The method of Embodiment D9 wherein the detected peaks represent returns of channel-specific pulses from objects in the channels.
Embodiment D11. The method of any of Embodiments D2-D10 wherein the generating step is performed by a plurality of channel-specific histogram circuits.
Embodiment D12. The method of any of Embodiments D1-D11 wherein the synchronizing step synchronizes the transmitting step with the sensing step so that, per cycle, each channel's histogram collection window is synchronized with randomized transmission times from the randomized transmission schedule for the channel-specific pulses which target that channel.
Embodiment D13. The method of any of Embodiments D1-D12 wherein each pixel comprises one or more photodetectors.
Embodiment D14. The method of Embodiment D13 wherein a plurality of the photodetectors comprise single photon avalanche photodetectors (SPADs).
Embodiment D15. The method of any of Embodiments D1-D14 wherein the light source array comprises a VCSEL array.
Embodiment D16. The method of any of Embodiments D1-D15 wherein the randomized transmission schedules comprise, for each channel, a plurality of randomized transmission times, wherein the randomized transmission times randomly spread out transmissions of the channel-specific pulses within the cycles of the channel-specific pulses.
Embodiment D17. The method of any of Embodiments D1-D16 wherein the method is perform by a lidar system, the lidar system comprising a lidar transmitter and a lidar receiver, the method further comprising:
   generating the randomized transmission schedules; and
   sharing the randomized transmission schedules with the lidar transmitter and the lidar receiver.
Embodiment D18. The method of any of Embodiments D1-D17 wherein the channel-specific histogram windows are subdivided into a plurality of cycle-specific, channel-specific histogram collection windows, and wherein a plurality of the cycle specific, channel-specific histogram collection windows are overlapping across a plurality of different channels.
Embodiment D19. The method of any of Embodiments D1-D18 further comprising a master clock generating a clock signal from which the transmitting and sensing steps are synchronized for the randomized transmission schedules and channel-specific histogram collection windows.
Embodiment D20. The method of Embodiment D19 further comprising a plurality of event detectors triggering the transmitting and sensing steps based on the clock signal.
Embodiment D21. The method of any of Embodiments D17-D20 wherein the master clock employs a phase locked loop to produce a multi-bit clock signal.
Embodiment D22. The method of any of Embodiments D1-D21 wherein the transmitting and sensing steps employ a number of cycles per lidar frame that is a value within a range between 10 cycles and 100,000 cycles.
Embodiment D23. The method of any of Embodiments D1-D21 wherein the transmitting and sensing steps a number of cycles per lidar frame that is a value within a range between 100 cycles and 10,000 cycles.
Embodiment D24. The method of any of Embodiments D1-D23 further comprising beginning the synchronized channel-specific histogram collection windows after a settle time for photodetectors of the pixels.
Embodiment D25. The method of any of Embodiments D1-D24 further comprising:
   computing range information for at least one object in the field of view based on channel-specific histogram data collected during at least one of the channel-specific histogram collection windows.
Embodiment D26. The method of any of Embodiments D1-D25 wherein the method is performed by a distributed lidar system, wherein distributed lidar system comprises a lidar receiver for performing the sensing step and a lidar transmitter for performing the transmitting step, wherein the lidar receiver and the lidar transmitter are physically distant from each other.
Embodiment D27. The method of any of Embodiments D1-D26 wherein the method is performed by a lidar system comprising a lidar transmitter and a lidar receiver, the method further comprising:
   the lidar transmitter using the channel-specific pulses to communicate message data to the lidar receiver.
Embodiment D28. The method of any of Embodiments D1-D27 further comprising any feature or combination of features set forth by any of Embodiments A1-B41.
Embodiment E1. A system, apparatus, method, and/or article of manufacture comprising any feature or combination of features described herein.

These and other modifications to the invention will be recognizable upon review of the teachings herein.

1. A lidar system comprising:
a lidar transmitter that transmits channel-specific light signals into a plurality of channels within a field of view, wherein the channel-specific light signals have corresponding channels to which they are transmitted and encode channel information for their corresponding channels; and
a lidar receiver, the lidar receiver comprising a plurality of channel-specific photodetectors, wherein the channel-specific photodetectors have corresponding channels within the field of view;
wherein the lidar receiver (1) senses incident light via a plurality of the channel-specific photodetectors, (2) produces channel-specific photodetection signals based on the incident light sensed by the channel-specific photodetectors, wherein the channel-specific photodetection signals include out-of-channel noise, and (3) filters the channel-specific photodetection signals based on the encoded channel information for their corresponding channels to reduce the out-of-channel noise.

2. The system of claim 1 wherein the lidar receiver detects returns from the channel-specific light signals based on the filtered channel-specific photodetection signals.

3. The system of claim 1 wherein the channel-specific light signals comprise a plurality of pulses in channel-specific pulse sequences, and wherein the lidar transmitter encodes the channel information in the channel-specific light signals as a function of magnitudes for the pulses of the channel-specific pulse sequences.

4. The system of claim 3 wherein the lidar receiver filters the channel-specific photodetection signals by (1) detecting a plurality of candidate return peaks for pulse sequence returns in the channel-specific photodetection signals and (2) determining whether the detected candidate return peaks correspond to return signals based on magnitude information for the detected candidate return peaks.

5. The system of claim 3 wherein the channel information is encoded in the channel-specific pulse sequences as ratios of magnitudes for the pulses in the channel-specific pulse sequences so that different channels are represented by different pulse magnitude ratios.

6. The system of claim 1 wherein the channel-specific light signals comprise a plurality of pulses in channel-specific pulse sequences, and wherein the lidar transmitter encodes the channel information in the channel-specific light signals as a function of time delays between the pulses of the channel-specific pulse sequences.

7. The system of claim 6 wherein the lidar receiver filters the channel-specific photodetection signals by (1) detecting a plurality of candidate return peaks for pulse sequence returns in the channel-specific photodetection signals and (2) determining whether the detected candidate return peaks correspond to return signals based on time delay information between the detected candidate return peaks.

8. The system of claim 1 wherein the encoded channel information comprises azimuth angles and/or elevation angles to which the channel-specific light signals are targeted.

9. The system of claim 1 wherein the encoded channel information comprises channel-specific randomizations for the channel-specific light signals.

10. The system of claim 9 wherein the channel-specific light signals comprise a plurality of channel-specific pulses, and wherein the channel-specific randomizations comprise randomized transmission times for the channel-specific pulses.

11. The system of claim 10 wherein the randomized transmission times comprise randomized transmission times for the channel-specific pulses over a plurality of cycles within a lidar frame.

12. The system of claim 9 wherein the lidar receiver (1) generates channel-specific histogram data based on the channel-specific photodetection signals and (2) filters the channel-specific photodetection signals based on (i) channel-specific synchronizations of the lidar receiver with transmissions of the channel-specific light signals and (ii) detections of peaks within the channel-specific histogram data.

13. A lidar method comprising:
transmitting channel-specific light signals into a plurality of channels within a field of view, wherein the channel-specific light signals have corresponding channels to which they are transmitted and encode channel information for their corresponding channels;
sensing incident light via a plurality of channel-specific photodetectors, wherein the channel-specific photodetectors have corresponding channels;
producing channel-specific photodetection signals based on the incident light sensed by the channel-specific photodetectors, wherein the channel-specific photodetection signals include out-of-channel noise; and
filtering the channel-specific photodetection signals based on the encoded channel information for their corresponding channels to reduce the out-of-channel noise.

14. A flash lidar system comprising:
a lidar receiver that receives and processes incident light from a field of view, wherein the field of view comprises a plurality of channels, the lidar receiver comprising a pixel array, the pixel array comprising a plurality of pixels, wherein the pixels have corresponding channels in the field of view; and
a lidar transmitter comprising a light source array, the light source array comprising a plurality of light emitters, wherein the light emitters have corresponding channels in the field of view and controllably emit channel-specific pulses of light into their corresponding channels at a plurality of times over a plurality of cycles according to randomized transmission schedules for the channel-specific pulses; and
wherein the lidar receiver synchronizes channel-specific histogram collection windows for the pixels to the randomized transmission schedules of the channel-specific pulses that are emitted into the pixels'corresponding channels.

15. The system of claim 14 wherein the lidar receiver generates channel-specific histogram data based on photon detections by the pixels during the channel-specific histogram collection windows, and wherein the randomized transmission schedules and synchronized channel-specific histogram collection windows operate to randomly spread out-of-channel noise across a plurality of bins within the channel-specific histogram data.

16. The system of claim 15 wherein the lidar receiver processes the channel-specific histogram data to detect returns of the channel-specific pulses from objects located in the channels.

17. The system of claim 16 wherein the lidar receiver detects the returns based on peaks within the channel-specific histogram data.

18. The system of claim 14 wherein the lidar receiver is synchronized with the lidar transmitter so that, per cycle, each channel's histogram collection window is synchronized with randomized transmission times from the randomized transmission schedule for the channel-specific pulses which target that channel.

19. The system of claim 14 further comprising a master clock that generates a clock signal from which operations of the lidar transmitter and lidar receiver are synchronized for the randomized transmission schedules and channel-specific histogram collection windows.

20. A flash lidar method for a lidar system that operates over a field of view, wherein the field of view comprises a plurality of channels, the method comprising:
controllably emitting channel-specific pulses of light into corresponding channels at a plurality of times over a plurality of cycles according to randomized transmission schedules for the channel-specific pulses;
synchronizing channel-specific histogram collection windows for a plurality of channel-specific pixels with the randomized transmission schedules for the channel-specific pulses that are emitted into the channel-specific pixels'corresponding channels; and
sensing returns of the channel-specific pulses from objects in the field of view via the channel-specific pixels using the synchronized channel-specific histogram collection windows.
